(19) United States
(12) Patent Application Publication
(10) Pub. No.: US 2012/0304294 A1
(43) Pub. Date: Nov. 29, 2012

(54) Network Monitoring Apparatus and Network Monitoring Method

(76) Inventor: Yuji Fujiwara, Hamura-shi (JP)

(21) Appl. No.: 13/571,224

(22) Filed: Aug. 9, 2012

Related U.S. Application Data
(63) Continuation of application No. 12/711,981, filed on Feb. 24, 2010.

(30) Foreign Application Priority Data
Mar. 18, 2009 (JP) 2009-066649

(51) Int. Cl. G06F 21/00; G06F 15/173

(52) U.S. Cl. 726/22

(57) ABSTRACT

According to one embodiment, a network monitoring apparatus includes an unauthorized node determination module, a spoofed address resolution protocol request transmission module, and a spoofed address resolution protocol reply transmission module. The unauthorized node determination module determines whether a sender node which transmits an address resolution protocol request packet is an unauthorized node. The spoofed address resolution protocol request transmission module transmits a spoofed address resolution protocol request packet to a target node corresponding to a target network address in the address resolution protocol request packet if the sender node is an unauthorized node. The spoofed address resolution protocol reply transmission module transmits to the unauthorized node a spoofed address resolution protocol reply packet which includes a predetermined physical address other than the physical address of the target node as a sender physical address and a network address of the target node as a sender network address.

### CROSS-REFERENCE TO RELATED APPLICATIONS

This application is a continuation application that is based upon and claims the benefit of priority from U.S. application Ser. No. 12/711,981, now abandoned, which is based upon and claims the benefit of priority from Japanese Patent Application No. 2009-066649, filed Mar. 18, 2009, the entire contents of which are incorporated herein by reference.

### BACKGROUND

1. Field

One embodiment of the invention relates to a network monitoring apparatus and a network monitoring method which monitor unauthorized accesses on a network.

2. Description of the Related Art

In recent years, various methods for dealing with unauthorized accesses on a network have been proposed. One of such methods uses an address resolution protocol (ARP).

The address resolution protocol (ARP) is a protocol for resolving a MAC address for a node whose IP address is known on a network.

Each node on the network transmits an address resolution protocol request (ARP request) and then writes the correspondence between IP addresses (or network addresses) and MAC addresses (or physical addresses) into an ARP table based on an address resolution protocol reply (ARP reply) transmitted from another node. Therefore, a false MAC address of another node can be written into the ARP table of the node by transmitting a spoofed ARP reply. When a false MAC address is written into its ARP table, the node cannot communicate normally. In other words, if a node is an unauthorized node, it is possible to block the communication by the unauthorized node.

Jpn. Pat. Appln. KOKAI Publication No. 2006-262019 has disclosed a network quarantine apparatus which receives an ARP request transmitted from an unauthorized terminal, transmits a spoofed ARP reply to the unauthorized terminal, and transmits a spoofed ARP request to an authorized terminal which the unauthorized terminal accesses. The network quarantine apparatus is capable of blocking the communication between the unauthorized terminal and authorized terminal by the spoofed ARP reply and the spoofed ARP request.

With the network quarantine apparatus in Jpn. Pat. Appln. KOKAI Publication No. 2006-262019, there is a possibility that the communication between the unauthorized terminal and authorized terminal will be performed in a period from when the network quarantine apparatus transmits a spoofed ARP reply until the unauthorized terminal receives the reply and in a period from when the network quarantine apparatus transmits a spoofed ARP request until the authorized terminal receives the request. Accordingly, it is necessary to realize a new function of shortening the period during which the communication between the unauthorized terminal and authorized terminal can be performed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an exemplary view of a network to which a network monitoring apparatus according to an embodiment of the invention is connected;

FIG. 2 is an exemplary diagram to explain the flow of data on the network of FIG. 1;

FIG. 3 is an exemplary block diagram showing a functional configuration of the network monitoring apparatus of the embodiment;

FIG. 4 is an exemplary table to explain the lists held by the network monitoring apparatus of the embodiment;

FIG. 5 is an exemplary table to explain an example of entries of the registered list and detection list of FIG. 4;

FIG. 6 is an exemplary table to explain an ARP packet transmitted and received by the network monitoring apparatus of the embodiment;

FIG. 7 is an exemplary table to explain an example of entries of the transmission list of FIG. 4;

FIG. 8 is an exemplary sequence diagram for a packet monitored by the network monitoring apparatus of the embodiment;

FIG. 9 is an exemplary ARP table of each node after the sequence of FIG. 8 has been completed;

FIG. 10 is an exemplary flowchart showing a procedure for an unauthorized PC exclusion process performed by the network monitoring apparatus of the embodiment;

FIG. 11 is another exemplary sequence diagram for a packet monitored by the network monitoring apparatus of the embodiment;

FIG. 12 is an exemplary ARP table of each node after the sequence of FIG. 11 has been completed;

FIG. 13 is an exemplary flowchart showing another procedure for an unauthorized PC exclusion process performed by the network monitoring apparatus of the embodiment;

FIG. 14 is another exemplary sequence diagram for a packet monitored by the network monitoring apparatus of the embodiment;

FIG. 15 is an exemplary ARP table of each node after the sequence of FIG. 14 has been completed;

FIG. 16 is another exemplary ARP table of each node after the sequence of FIG. 14 has been completed;

FIG. 17 is another exemplary sequence diagram for a packet monitored by the network monitoring apparatus of the embodiment;

FIG. 18 is an exemplary ARP table of each node after the sequence of FIG. 17 has been completed;

FIG. 19 is another exemplary sequence diagram for a packet monitored by the network monitoring apparatus of the embodiment;

FIG. 20 is an exemplary ARP table of each node after the sequence of FIG. 19 has been completed;

FIG. 21 is an exemplary block diagram showing an example of realizing the network monitoring apparatus of the embodiment using multithreads;

FIG. 22 is an exemplary flowchart showing a procedure for a reception process using reception threads of FIG. 21;

FIG. 23 is an exemplary flowchart showing a procedure for a name resolution process using name resolution threads of FIG. 21;

FIG. 24 is an exemplary flowchart showing a procedure for a transmission process using transmission threads of FIG. 21;

FIG. 25 is an exemplary flowchart showing another procedure for a reception process using reception threads of FIG. 21; and

FIG. 26 is an exemplary flowchart showing another procedure for a transmission process using transmission threads of FIG. 21.

### DETAILED DESCRIPTION

Various embodiments according to the invention will be described hereinafter with reference to the accompanying drawings. In general, according to one embodiment of the invention, there is provided a network monitoring apparatus which is configured to monitor a network to which nodes are connected, the network monitoring apparatus comprising: an unauthorized node determination module configured to determine whether a sender node which transmits an address resolution protocol request packet is an unauthorized node, based on a sender physical address in the address resolution protocol request packet, in response to the reception of the address resolution protocol request packet; a spoofed address resolution protocol request transmission module configured to transmit a spoofed address resolution protocol request packet which includes a physical address of the network monitoring apparatus as a sender physical address and a network address of the unauthorized node as a sender network address to a target node corresponding to a target network address in the received address resolution protocol request packet if the sender node is an unauthorized node; and a spoofed address resolution protocol reply transmission module configured to transmit to the unauthorized node a spoofed address resolution protocol reply packet which includes a predetermined physical address other than the physical address of the target node as a sender physical address and a network address of the target node as a sender network address, in response to the reception of an address resolution protocol reply packet transmitted from the target node with respect to the spoofed address resolution protocol request packet.

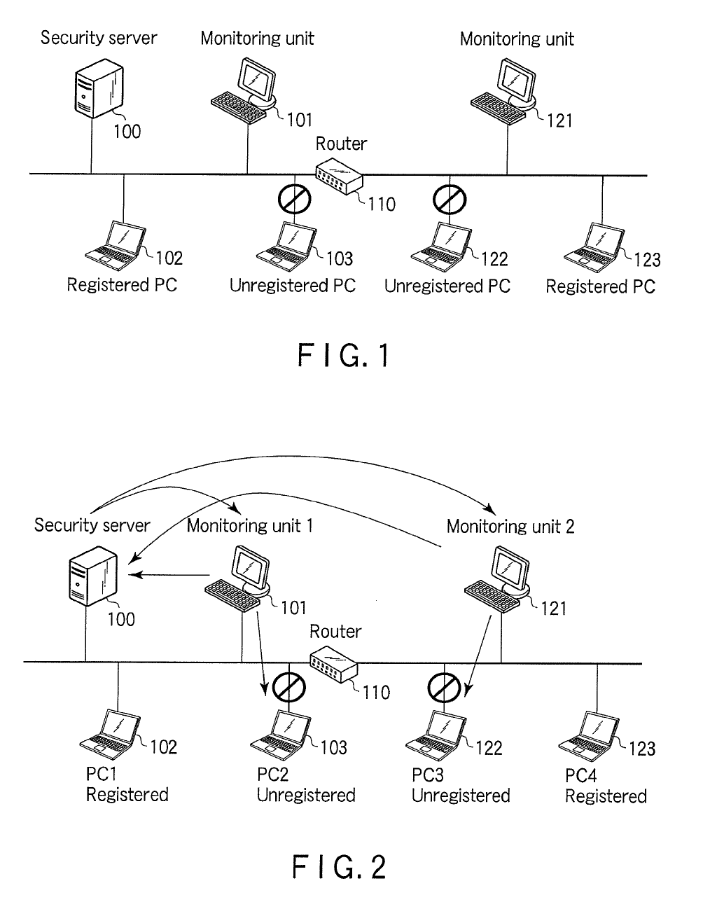

First, a network to which a network monitoring apparatus of an embodiment of the invention is connected will be explained with reference to FIG. 1. The network monitoring apparatus is realized by, for example, a personal computer.

A security server 100, monitoring units 101, 121, a router 110, registered computer 102, 123, and unregistered computers 103, 122 are connected to the network. A segment to which the security server 100, monitoring unit 101, registered computer 102, and unregistered computer 103 are connected and a segment to which the monitoring unit 121, unregistered computer 122, and registered computer 123 are connected are connected to each other via the router 110.

On the network, only the communication performed by the security server 100, monitoring units 101, 121, and registered computers 102, 123 is permitted. The unregistered computers 103, 122 are treated as unauthorized computers. The communication performed by the unregistered computers 103, 122 is blocked, thereby excluding unauthorized accesses on the network.

The security server 100 holds a registered list in which information on the registered computers on the network is written. In the registered list, for example, the MAC addresses (or physical addresses), IP addresses (or network addresses), and host names of the registered computers 102, 123 are written. The registered list is created and updated on the security server 100. The security server 100 distributes the registered list to the monitoring units 101, 121.

The security server 100 receives detection lists in which information on the unregistered computers 103, 122 newly detected by the monitoring units 101, 121 has been written from the monitoring units 101, 121, respectively. Based on the received detection lists, the security server 100 updates the registered list. The registered list may be updated manually on the security server 100.

The monitoring units 101, 121 monitor the packets on the network, detect accesses (unauthorized accesses) from the unregistered computers 103, 122, and exclude the unauthorized accesses. Specifically, if the monitoring units 101, 121 detect address resolution protocol request packets (ARP request packets) transmitted from the unregistered computers 103, 122 or address resolution protocol request packets (ARP request packets) transmitted to the unregistered computers 103, 122, the monitoring units 101, 121 execute the process of blocking accesses from the unregistered computers 103, 122.

The address resolution protocol (ARP) is a protocol for resolving a MAC address for a node whose IP address is known on the network. When communication is performed between two nodes, a first and a second node, the first node broadcasts an address resolution protocol request packet (ARP request packet) which specifies the IP address of the second node on the network to check the MAC address of the second node as the target, before communicating with the second node. The second node which has received the ARP request packet transmits (unicasts) an address resolution protocol reply packet (ARP reply packet) including the MAC address of the second node to the first node. The first node detects the MAC address of the second node in the ARP reply packet and writes the IP address and MAC address of the second node into the ARP table in the first node. From this point on, when communication is performed between the two nodes, the first node refers to the ARP table and transmits packets to the MAC address of the second node written in the ARP table.

When the node which transmitted an ARP request packet has received a plurality of ARP reply packets responding to the ARP request packet, it processes the ARP reply packets in the order in which it received the packets. That is, a node which transmitted one ARP request packet can receive a plurality of ARP reply packets. Moreover, even a node which transmitted no ARP request packet can also receive a plurality of ARP reply packets and process the ARP reply packets in the order in which it received the packets.

As described above, since the first node write the ARP table based on an ARP reply, a false MAC address different from the MAC address of the second node can be written into the ARP table of the first node by transmitting a spoofed ARP reply to the first node. After a false MAC address has been written in its ARP table, the first node cannot perform normal communication. Accordingly, if the first node is an unauthorized node, the communication performed by the first node can be blocked.

Using such ARP behavior, it is possible to exclude accesses from the unregistered computers 103, 122 to another node on the network and accesses from another node on the network to the unregistered computers 103, 122.

The monitoring units 101, 121 write information on the newly detected unregistered computers 103, 122 into a detection list and transmits the detection list to the security server 100 at specific intervals of time or according to an instruction given by the security server 100. In the detection list, for example, the MAC addresses (physical addresses), IP addresses (network addresses), and host names of the unregistered computers 103, 122 are written as information on the unregistered computers 103, 122.

The monitoring units 101, 121 are set in one of the following operation modes: the units 101, 121 are set in a collection mode in which information on the unregistered computers 103, 122 is written into a detection list when detecting the unregistered computers 103, 122; and the units 101, 121 are set in a block mode in which information on the unregistered computers 103, 122 is written into a detection list and unauthorized accesses from the unregistered computers 103, 122 are excluded when detecting the unregistered computers 103, 122.

One or more units of the monitoring units 101, 121 are provided on each segment. The monitoring unit 101 provided on the same segment as the security server 100 may also function as the security server 100.

FIG. 2 is a diagram to explain the flow of data on the network.

The security server 100 transmits the registered list and information indicating the operation mode to the monitoring units 101, 121. In the registered list, information on the registered computers 102, 123 is written.

The monitoring units 101, 121 operate in either the collection mode or block mode based on information indicating the received operation mode.

The monitoring units 101, 121 monitor ARP request packets in the segments belonging to the respective units 101, 121. By the monitoring, the monitoring unit 101 detects the registered computer 102 and the unregistered computer 103. The monitoring unit 121 detects the unregistered computer 122 and the registered computer 123.

When operating in the collection mode, the monitoring unit 101 writes information on the unregistered computer 103 into the detection list in the monitoring unit 101. The monitoring unit 121 writes information on the unregistered computer 122 into the detection list in the monitoring unit 121. The monitoring units 101, 121 transmit the detection lists to the security server 100.

When operating in the block mode, the monitoring unit 101 writes information on the unregistered computer 103 into the detection list in the monitoring unit 101 and excludes unauthorized accesses from the unregistered computer 103. The monitoring unit 121 writes information on the unregistered computer 122 into the detection list in the monitoring unit 121 and excludes unauthorized accesses from the unregistered computer 122.

The monitoring units 101, 121 block unauthorized access from the unregistered computer 103 to the registered computer 102 and unauthorized accesses from the unregistered computer 122 to the registered computer 123, taking the following three measures.

Firstly, the monitoring unit 101 registers a pair of the IP address of the unregistered computer 103 and the MAC address of the monitoring unit 101 in the ARP table of the computer 102 targeted by the unregistered computer 103. Accordingly, the monitoring unit 101 transmits to the target computer 102 a spoofed ARP request which includes the MAC address of the monitoring unit 101 as a source MAC address and the IP address of the unregistered computer 103 as a source IP address.

Secondly, the monitoring unit 101 registers a pair of the IP address of the target computer 102 and the MAC address of the unregistered computer 103 in the ARP table of the unregistered computer 103. Accordingly, the monitoring unit 101 transmits to the unregistered computer 103 a spoofed ARP reply which includes the MAC address of the unregistered computer 103 as a source MAC address and the IP address of the target computer 102 as a source IP address.

Thirdly, the monitoring unit 101 registers a pair of the IP address of the unregistered computer 103 and the MAC address of the monitoring unit 101 in the ARP table of the monitoring unit 101, thereby spoofing the ARP table.

With the three measures, each of the monitoring units 101, 121 blocks unauthorized accesses from the unregistered computer 103 to the target registered computer 102 and unauthorized accesses from the unregistered computer 122 to the target registered computer 123.

Furthermore, each of the monitoring units 101, 121 transmits the detection list therein to the security server 100.

Having received the detection list, the security server 100 writes information on a newly registered one of the unregistered computers 103, 122 into the registered list based on the detection list.

Hereinafter, the network monitoring apparatus of the embodiment will be explained, centering on the monitoring unit 101. Suppose another monitoring unit on the network, such as the monitoring unit 121, operates as the monitoring unit 101. Hereinafter, it is assumed that the monitoring unit 101 excludes unauthorized accesses from the unregistered computer 103 to the registered computer 102.

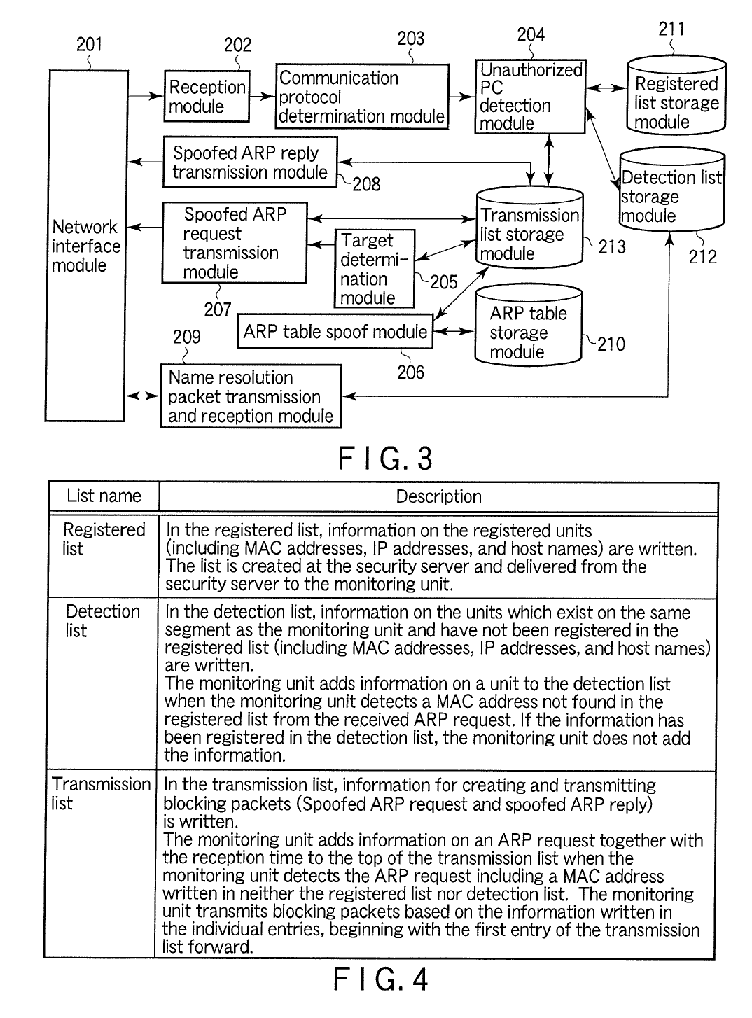

FIG. 3 is a block diagram showing a functional configuration of the monitoring unit 101.

The monitoring unit 101 includes a network interface module 201, a reception module 202, a communication protocol determination module 203, an unauthorized PC detection module 204, a target determination module 205, an ARP table spoof module 206, a spoofed ARP request transmission module 207, a spoofed ARP reply transmission module 208, a name resolution packet transmission and reception module 209, an ARP table storage module 210, a registered list storage module 211, a detection list storage module 212, and a transmission list storage module 213.

The network interface module 201 is an interface for connecting the monitoring unit 101 to the network. The network interface module 201 controls the transmission and reception of, for example, packets transmitted from the monitoring unit 101 to another node and packets received by the monitoring unit 101 from another node. The network interface module 201 is connected to the modules which transmit and receive packets, including the reception module 202, spoofed ARP request transmission module 207, spoofed ARP reply transmission module 208, and name resolution packet transmission and reception module 209.

The reception module 202 receives packets transmitted from another node via the network interface module 201. The received packets include broadcast packets and packets addressed to the MAC address of the monitoring unit 101. The reception module 202 outputs the data of the received packet to the communication protocol determination module 203.

The communication protocol determination module 203 determines the protocol of the received packet. If the protocol of the received packet is ARP, the communication protocol determination module 203 outputs the data of the received packet, that is, the data of the ARP packet, to the unauthorized PC detection module 204.

Referring to the registered list in the registered list storage module 211 and the detection list in the detection list storage module 212, the unauthorized PC detection module 204 determines whether the source computer which transmitted the received packets is an unauthorized computer, or an unregistered computer.

In the monitoring unit 101, to detect an unauthorized computer, the registered list is stored in the registered list storage module 211 and the detection list is stored in the detection list storage module 212. Moreover, in the monitoring unit 101, the transmission list is stored in the transmission list storage module 213 to exclude an unauthorized computer.

Each of the registered list, detection list, and transmission list will be explained with reference to FIGS. 4 to 7.

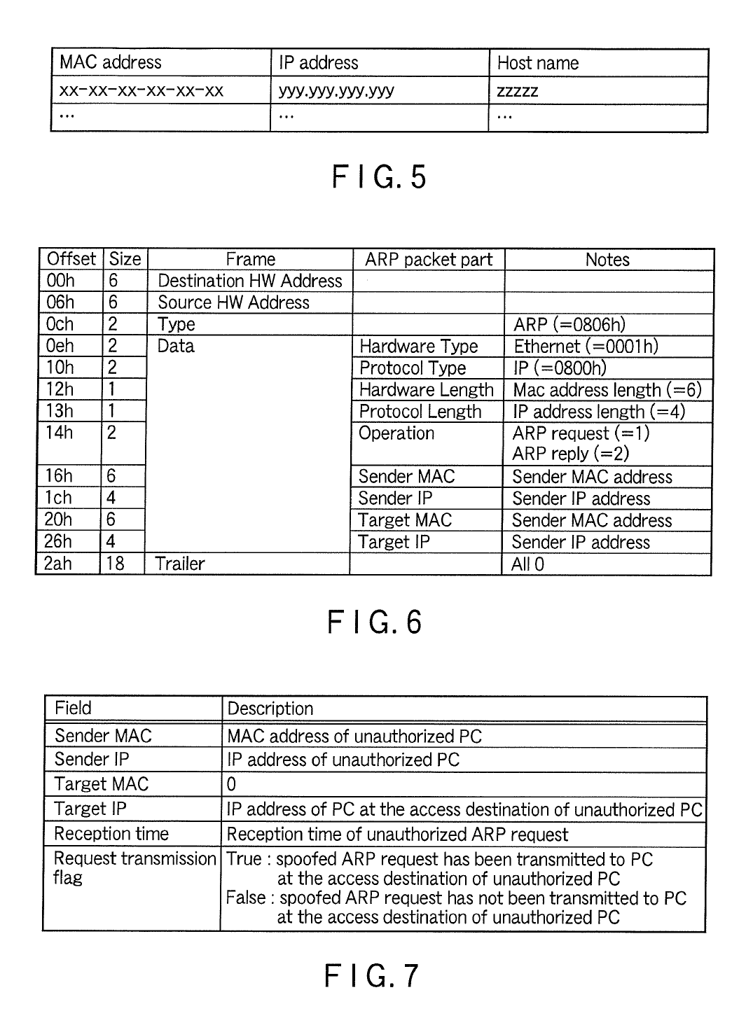

The registered list is a list in which information on the registered computers is written. Each entry stored in the registered list includes the MAC address, IP address, and host name of one registered computer. FIG. 5 shows a description of each entry. In the field of the MAC address, the value of the MAC address (physical address) unique to the unit is written. In the field of the IP address, the value of the IP address (network address) allocated on the network is written. In the field of the host name, a name obtained by name resolution or the like based on the IP address is written. The registered list is created at the security server 100 and is distributed from the security server 100 to the monitoring unit 101. On the network of FIG. 2, the security server 100 writes information on the registered computers 102, 123 into the registered list.

The detection list is a list in which information on a computer which exists on the same segment as the monitoring unit 101 and has not been written in the registered list is written. Each entry stored in the detection list includes the MAC address, IP address, and host name of an unauthorized computer. As in the registered list, each entry is described as shown in FIG. 5. In the field of the MAC address, the value of the MAC address (physical address) unique to the unit is written. In the field of the IP address, the value of the IP address (network address) allocated on the network is written. In the field of the host name, a name obtained by name resolution or the like based on the IP address is written. The field of the host name may be blank.

If the source MAC address in the received ARP request packet is not registered in the registered list, the unauthorized PC detection module 204 of the monitoring unit 101 determines that the source computer of the ARP request packet is an unauthorized computer and adds to the detection list an entry that describes information on the source computer. If information on the source computer has been registered in the detection list, the unauthorized PC detection module 204 does not add a new entry.

FIG. 6 shows a format for an Ethernet (a registered trademark) frame including the ARP packet part.

The Ethernet frame is composed of the following fields from the beginning in this order: six bytes of destination hardware address (Destination HW Address), six bytes of source hardware address (Source HW Address), two bytes of protocol type (Type), up to 1500 bytes of data part (Data), and 18 bytes of trailer (Trailer).

The destination hardware address represents the MAC address (physical address) of the unit (node) at the destination of the Ethernet frame. The source hardware address represents the MAC address (physical address) of the unit (node) at the source of the Ethernet frame. The protocol type indicates the type of a communication protocol in the upper layer of Ethernet. When communication is performed by the ARP, “0806h” is set in the protocol type field.

The data part includes the values in the individual fields set for each protocol specified in the protocol type. When ARP is specified in the protocol type, the data part is composed of fields necessary for an ARP packet. Accordingly, the data part (ARP packet part) is composed of the following fields: two bytes of hardware type (Hardware Type), two bytes of protocol type (Protocol Type), one byte of MAC address length (Hardware Length), one byte of IP address length (Protocol Length), two bytes of operation (Operation), six bytes of sender MAC address (Sender MAC), four bytes of sender IP address (Sender IP), six bytes of target MAC address (Target MAC), and four bytes of target IP address (Target IP).

The hardware type indicates the type of a physical medium on the network. In the case of Ethernet, “0001h” is set in the hardware type field.

The protocol type indicates the type of a protocol dealt with in the ARP protocol. In the case of IP, “0800h” is set in the protocol type field.

The MAC address length represents the length of a MAC address. In the case of Ethernet, the length of a MAC address is six bytes. In the MAC address length field, “06h” is set.

The IP address length represents the length of an IP address. In the case of Version 4 of IP (IPv4), the length of an IP address is four bytes. In the IP address length field, “04h” is set.

The operation represents the type of ARP operation. In communication by ARP, first, one computer transmits an ARP request. A computer corresponding to the ARP request returns an ARP reply. Accordingly, in the operation field, a value to distinguish between a request and a reply is set. Specifically, if an ARP packet is an ARP request packet, “0001h” is set in the operation field. If an ARP packet is an ARP reply packet, “0002h” is set in the operation field.

The sender MAC address represents a MAC address (physical address) unique to the sender unit (node). Accordingly, the same value is set in both the field of the sender hardware address of an Ethernet frame and the field of the sender MAC address of the ARP packet part.

The sender IP address represents an IP address (network address) allocated to the sender unit (node).

The target MAC address represents a MAC address (physical address) unique to the target unit (node). Accordingly, the same value is set in both the field of the target hardware address of an Ethernet frame and the field of the target MAC address of the ARP packet part. When the ARP packet is an ARP request packet (or when a value corresponding to the ARP request has been set in the operation field), the target MAC address is unknown. Therefore, “0” is set in the field of the target MAC address.

The target IP address indicates an IP address (network address) allocated to the target unit (node).

The trailer is a data string added to the tail end of an Ethernet frame. The trailer is used for an error-correcting code or the like.

When an ARP request packet based on the above format has been received, the unauthorized PC detection module 204 first extracts the sender MAC address from the received ARP request packet. Then, if the sender MAC address has been written in the registered list, the unauthorized PC detection module 204 determines that the sender computer is a registered computer.

Moreover, if the sender MAC address has not been written in the registered list, the unauthorized PC detection module 204 determines that the sender computer is an unauthorized computer. If it has been determined that the sender computer is an unauthorized computer, the unauthorized PC detection module 204 adds to the detection list an entry in which the sender MAC address and sender IP address in the received ARP request packet have been written. Then, the unauthorized PC detection module 204 writes the information in the ARP request packet together with the reception time into the transmission list stored in the transmission list storage module 213. If the entry in which the sender MAC address and sender IP address in the received ARP request packet has been written has been registered in the detection list, the unauthorized PC detection module 204 does not add the entry to the detection list.

As described above, by determining based on only the sender MAC address in the received ARP request packet whether the sender computer is an unauthorized computer, it is possible to determine whether the sender computer in the ARP request packet is an unauthorized computer even in a case where the correspondence between IP addresses and MAC addresses changes dynamically in a DHCP environment or a case where an unauthorized computer spoofs an IP address.

As shown in FIG. 4, the transmission list is a list in which information is written to create a blocking packet for excluding unauthorized computers on the network and to transmit the packet. The blocking packet includes an ARP request packet (spoofed ARP request packet) and an ARP reply packet (spoofed ARP reply packet) which spoof the correspondence between the sender MAC address and sender IP address. When having received an ARP request packet including a sender MAC address not registered in the registered list, that is, when having received an ARP request broadcast from an unauthorized computer, the unauthorized PC detection module 204 adds an entry including information on the ARP request packet to the transmission list.

FIG. 7 shows an example of the fields constituting each entry of the transmission list.

The entries of the transmission list is composed of a sender MAC address, a sender IP address, a target MAC address, a target IP address, a reception time, and a request transmission flag.

The sender MAC address (Sender MAC) represents the MAC address of an unauthorized computer. Accordingly, in the field of the sender MAC address, the value of the sender MAC address in the ARP request transmitted from the unauthorized computer is set.

The sender IP address (Sender IP) represents the IP address of the unauthorized computer. Accordingly, in the field of the sender IP address, the value of the sender IP address in the ARP request transmitted from the unauthorized computer is set.

The target MAC address (Target MAC) indicates 0. This is because 0, the value of the target MAC address in the ARP request transmitted from the unauthorized computer, is set in the field of the target MAC address.

The target IP address (Target IP) represents the IP address of the computer accessed by the unauthorized computer. Accordingly, in the field of the target IP address, the value of the target IP address in the ARP request transmitted from the unauthorized computer is set.

The reception time shows the time that the monitoring unit 101 received the ARP request transmitted from the unauthorized computer.

The request transmission flag indicates whether a spoofed ARP request packet has been transmitted to the computer which the unauthorized computer accesses. Accordingly, in the field of the request transmission flag, “True” is set if a spoofed ARP request packet has been transmitted to the computer which the unauthorized computer accesses and “False” is set if a spoofed ARP request packet has not been transmitted.

Entries based on the aforementioned fields are added to the transmission list. Referring to the transmission list, the monitoring unit 101 carries out the process of excluding unauthorized computers.

The target determination module 205 of the monitoring unit 101 determines whether the target IP address written in the entry read from the transmission list coincides with the IP address of the monitoring unit 101. The target determination module 205 outputs the determination result to the spoofed ARP request transmission module 207.

The ARP table spoof module 206 performs the process of spoofing the ARP table stored in the ARP table storage module 210. The ARP table is a table in which pairs of an IP address and a MAC address are written. Each node holds the corresponding ARP table and registers a pair of the sender IP address and sender MAC address in the received ARP request packet and a pair of the sender IP address and sender MAC address in the received ARP reply packet in the ARP table. If an IP address to be registered has been already registered in the ARP table, the MAC address caused to correspond to the IP address is overwritten with the sender MAC address in the received ARP request packet or ARP reply packet in the ARP table.

The ARP table spoof module 206 causes the MAC address of the monitoring unit 101 to correspond to the IP address of the unregistered computer 103 and overwrites the ARP table. By causing a false MAC address to correspond to the IP address of the unregistered computer 103, it is possible to prevent the communication from the registered computer 102 to the unregistered computer 103 from being established through the redirection from the monitoring unit 101 to the unregistered computer 103 when ICMP redirect is activated.

If the target determination module 205 has determined that the target IP address written in the entry read from the transmission list does not coincide with the IP address of the monitoring unit 101, the spoofed ARP request transmission module 207 transmits a spoofed ARP request packet to the computer at the target of the unauthorized computer. The spoofed ARP request transmission module 207 creates a spoofed ARP request packet based on the information written in the entry read from the transmission list.

In the individual fields constituting the spoofed ARP request packet, values are set as described below.

In the field of the sender IP address, the sender IP address written in an entry of the transmission list is set. In the field of the sender MAC address, the MAC address of the monitoring unit 101 is set. In the field of the target IP address, the target IP address written in an entry of the transmission list is written. In the field of the target MAC address, “0” is set.

Accordingly, for example, in the field of the sender IP address, the IP address of the unregistered computer 103 is set. In the field of the sender MAC address, the MAC address of the monitoring unit 101 is set. In the field of the target IP address, the IP address of the registered computer 102 is written. In the field of the target MAC address, “0” is set.

The spoofed ARP reply transmission module 208 transmits a spoofed ARP reply packet to the unauthorized computer. The spoofed ARP reply transmission module 208 creates a spoofed ARP reply packet based on the information written in the entry read from the transmission.

In the individual fields constituting a spoofed ARP reply packet, the following values are set. In the field of the sender IP address, the target IP address written in an entry of the transmission list is set. In the field of the sender MAC address, the sender MAC address written in an entry of the transmission list is set. In the field of the target IP address, the sender IP address written in an entry of the transmission list is written. In the field of the target MAC address, the sender MAC address written in an entry of the transmission list is set.

Accordingly, for example, in the field of the sender IP address, the IP address of the registered computer 102 is set. In the field of the sender MAC address, the MAC address of the unregistered computer 103 is set. In the field of the target IP address, the IP address of the unregistered computer 103 is written. In the field of the target MAC address, the MAC address of the unregistered computer 103 is set.

The name resolution packet transmission and reception module 209 reads an entry composed of the MAC address and IP address registered in the detection list, acquires a host name corresponding to the IP address, and updates the detection list based on the entry to which the host name has been added. Based on the IP address, the name resolution packet transmission and reception module 209 performs name resolution by, for example, DNS or NetBIOS. By adding a host name to each entry of the detection list, a node can be accessed based on the node name.

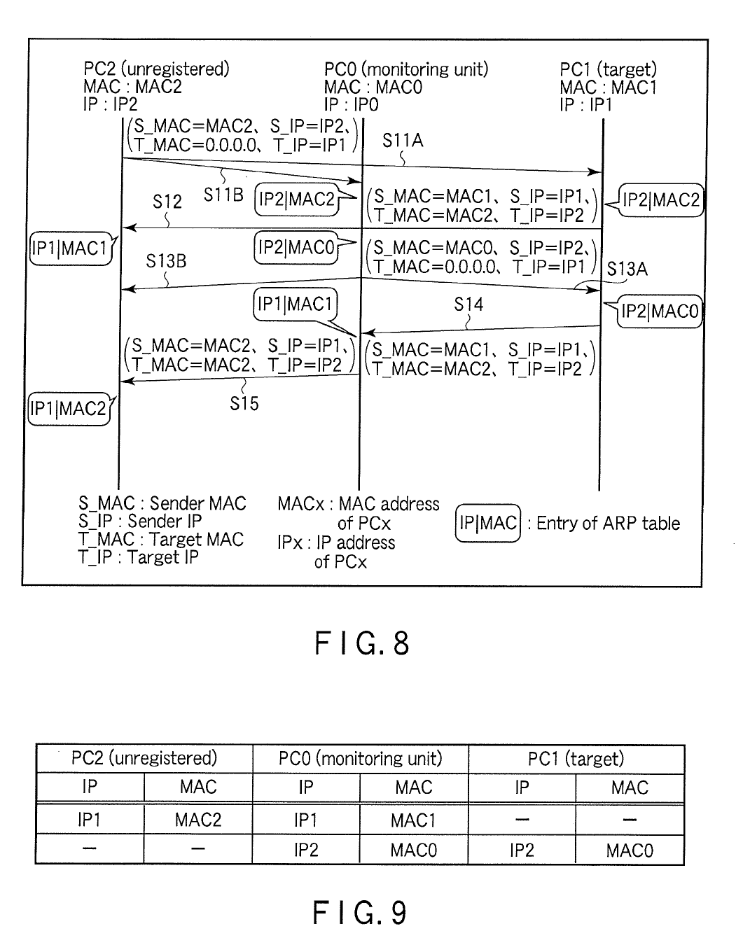

FIG. 8 is a sequence diagram showing an example of how the monitoring unit 101 functioning as the network monitoring apparatus of the embodiment excludes unauthorized accesses. Here, suppose the monitoring unit 101 excludes an unauthorized access from the unregistered computer 103, an unauthorized computer, to the registered computer 102. Let the MAC address of the monitoring unit 101 be MAC0, the IP address of the monitoring unit 101 be IP0, the MAC address of the registered computer 102 be MAC1, the IP address of the registered computer 102 be IP1, the MAC address of the unregistered computer 103 be MAC2, and the IP address of the unregistered computer 103 be IP2.

First, the unregistered computer 103 broadcasts an ARP request packet to inquire about the MAC address of the registered computer 102 at the access destination (target) (S11A, S11B). Because of transmission by broadcast, both the monitoring unit 101 and registered computer 102 receive an ARP request packet. The ARP request packet includes the sender MAC address representing the MAC address (MAC2) of the unregistered computer 103, the sender IP address representing the IP address (IP2) of the unregistered computer 103, the target MAC address representing “0” to inquire about the MAC address of the registered computer 102, and the target IP address representing the IP address (IP1) of the registered computer 102. Each of the monitoring unit 101 and registered computer 102 registers a pair of the IP address (IP2) and MAC address (MAC2) of the unregistered computer 103 in the respective ARP table.

Having received the ARP request packet, the registered computer 102 to which the broadcast ARP request packet is addressed unicasts an ARP reply packet to the unregistered computer 103 (S12). The ARP reply packet includes the sender MAC address representing the MAC address (MAC1) of the registered computer 102, the sender IP address representing the IP address (IP1) of the registered computer 102, the target MAC address representing the MAC address (MAC2) of the unregistered computer 103, and the target IP address representing the IP address (IP2) of the unregistered computer 103. Because of transmission by unicast, only the unregistered computer 103 receives the ARP reply packet and the monitoring unit 101 cannot receive the ARP reply packet. The unregistered computer 103 registers a pair of the IP address (IP1) and MAC address (MAC1) of the registered computer 102 in the ARP table. This makes it possible to transmit and receive packets between the unregistered computer 103 and registered computer 102.

Furthermore, the monitoring unit 101 spoofs its own ARP table by rewriting a pair of the IP address (IP2) and MAC address (MC2) of the unregistered computer 103 registered in the ARP table. The monitoring unit 101 registers a pair of the IP address (IP2) of the unregistered computer 103 and the MAC address (MAC0) of the monitoring unit 101. This prevents the communication from the registered computer 102 to the unregistered computer 103 from being established by the redirect function of the monitoring unit 101.

Then, to rewrite the IP address (IP2) and MAC address (MC2) of the unregistered computer 103 registered in the ARP table of the registered computer 102, the monitoring unit 101 broadcasts a spoofed ARP request packet generated by spoofing the MAC address of the unregistered computer 103 as the MAC address (MAC0) of the monitoring unit 101 (S13A, S13B). Accordingly, the spoofed ARP request packet includes the sender MAC address representing the MAC address (MAC0) of the monitoring unit 101, the sender IP address representing the IP address (IP2) of the unregistered computer 103, the target MAC address representing “0” to inquire about the MAC address of the registered computer 102, and the target IP address representing the IP address (IP1) of the registered computer 102. Because of transmission by broadcast, the unregistered computer 103 and registered computer 102 both receive the spoofed ARP request packet. However, since the unregistered computer 103 is not the target of the spoofed ARP request packet, it ignores the packet. The registered computer 102 registers a pair of the IP address (IP2) of the unregistered computer 103 and the MAC address (MAC0) of the monitoring unit 101 in the ARP table. This makes it possible to block the transmission of packets from the registered computer 102 to the unregistered computer 103.

Having received the spoofed ARP request packet, the registered computer 102 unicasts an ARP reply packet to the monitoring unit 101 (S14). The ARP reply packet includes the sender MAC address representing the MAC address (MAC1) of the registered computer 102, the sender IP address representing the IP address (IP1) of the registered computer 102, the target MAC address representing the MAC address (MAC0) of the monitoring unit 101, and the target IP address representing the IP address (IP2) of the unregistered computer 103. The monitoring computer 101 registers a pair of the IP address (IP1) and MAC address (MAC1) of the registered computer 102 in the ARP table.

When having received the ARP reply packet from the registered computer 102, the monitoring unit 101 determines that the registered computer 102 has transmitted a normal ARP reply packet to the unregistered computer 103 (S12). Then, the monitoring unit 101 unicasts a spoofed ARP reply packet which spoofs the MAC address of the registered computer 102 as MAC2 (the MAC address of the unregistered computer 103) (S15). Accordingly, the spoofed ARP reply packet includes the sender MAC address representing the MAC address (MAC2) of the unregistered computer 103, the sender IP address representing the IP address (IP1) of the registered computer 102, the target MAC address representing the MAC address (MAC2) of the unregistered computer 103, and the target IP address representing the IP address (IP2) of the unregistered computer 103. The unregistered computer 103 registers a pair of the IP address (IP1) of the registered computer 102 and the MAC address (MAC2) of the unregistered computer 103 in the ARP table. This makes it possible to block the transmission of packets from the unregistered computer 103 to the registered computer 102.

As a result of the aforementioned processes, the ARP table of each node is written as shown in FIG. 9.

In the ARP table of the unregistered computer 103, a pair of the IP address (IP1) of the registered computer 102 and the MAC address (MAC2) of the unregistered computer 103 is registered. In the ARP table of the monitoring unit 101, a pair of the IP address (IP1) and MAC address (MAC1) of the registered computer 102 is registered. Moreover, in the ARP table of the monitoring unit 101, a pair of the IP address (IP2) of the unregistered computer 103 and the MAC address (MAC0) of the monitoring unit 101 is registered. In the ARP table of the registered computer 102, a pair of the IP address (IP2) of the unregistered computer 103 and the MAC address (MAC0) of the monitoring unit 101 is registered.

Writing the ARP table of each node as described above makes it possible to block the transmission of packets from the unregistered computer 103 to the registered computer 102, the transmission of packets from the registered computer 102 to the unregistered computer 103, and the transmission of packets from the registered computer 102 with the redirect function of the monitoring unit 101 to the unregistered computer 103.

As described above, during the time from when the unregistered computer 103 transmits an ARP request packet to the registered computer 102 (S11A) and receives an ARP reply packet from the registered computer 102 (S12) until it receives a spoofed ARP reply packet from the monitoring unit 101 (S15), the unregistered computer 103 can transmit a packet to the registered computer 102. Accordingly, after receiving an ARP request packet broadcast from the unregistered computer 103 (S11B), the monitoring unit 101 transmits a spoofed ARP request packet to the registered computer 102 immediately, thereby blocking the transmission (or return) of a packet from the registered computer 102 to the unregistered computer 103.

The spoofed ARP reply packet transmitted from the monitoring unit 101 (S15) has to be received by the unregistered computer 103 after a normal ARP reply packet transmitted from the registered computer 102 (S12). The reason for this is that, after a pair of the IP address (IP1) and MAC address (MAC1) of the registered computer 102 is registered in the ARP table of the unregistered computer 103 on the normal ARP reply packet, the MAC address caused to correspond to the IP address (IP1) of the registered computer 102 is updated to the MAC address (MAC2) of the unregistered computer 103 based on the spoofed ARP reply packet and the MAC address (MAC2) is registered.

Since the spoofed ARP request packet (S13A) reaches the registered computer 102 after the ARP request packet (S11A) transmitted from the unregistered computer 103, an ARP reply packet (S14) in response to the spoofed ARP request packet (S13A) is transmitted from the registered computer 102 after an ARP reply packet (S12) in response to the ARP request packet (S11A) is transmitted. Accordingly, the monitoring unit 101 waits for an ARP reply packet (S14) in response to the spoofed ARP request packet (S13A) transmitted from the registered computer 102 and, after receiving the ARP reply packet, transmits a spoofed ARP reply packet to the unregistered computer 103 (S15), thereby enabling the unregistered computer 103 to receive the spoofed ARP reply packet (S15) after the normal ARP reply packet (S12) transmitted from the registered computer 102.

The spoofed ARP reply packet (S15) may be a spoofed ARP request packet. The spoofed ARP request packet includes the sender MAC address representing the MAC address (MAC2) of the unregistered computer 103, the sender IP address representing the IP address (IP1) of the registered computer 102, the target MAC address representing “0” to inquire about the MAC address of the unregistered computer 103, and the target IP address representing the IP address (IP2) of the unregistered computer 103. When the spoofed ARP request packet is transmitted to the unregistered computer 103, there is a possibility that an unnecessary packet will be sent onto the network since the unregistered computer 103 transmits an ARP reply packet in response to the spoofed ARP request packet.

The monitoring unit 101 can also block the communication between the unregistered computer 103 and the registered computer 102 in the following procedure. The monitoring unit 101 receives an ARP request packet from the unregistered computer 103 (unauthorized computer), waits for a specific length of time, and then transmits a spoofed ARP reply packet to the unregistered computer 103. Then, the monitoring unit 101 transmits a spoofed ARP request packet to the registered computer 102 of the target.

In this case, to cause the unregistered computer 103 to receive a spoofed ARP reply packet after the unregistered computer 103 has received an ARP reply packet from the registered computer 102, the monitoring unit 101 has to wait for a specific length of time after having received an ARP request packet from the unregistered computer 103 as described above. During the specific length of time, the monitoring unit 101 cannot exclude unauthorized accesses from the unregistered computer 103 to the registered computer 102 and accesses (responses) from the registered computer 102 to the unregistered computer 103. If a sufficient length of time is not secured as the specific length of time, a spoofed ARP reply packet might have to be retransmitted to the unregistered computer 103.

First, the monitoring unit 101 functioning as the network monitoring apparatus of the embodiment transmits a spoofed ARP request packet to the registered computer 102 with which the unregistered computer 103 targets. This makes it possible to shorten the time during which the communication from the registered computer 102 to the unregistered computer 103 can be performed. Being triggered by the reception of an ARP reply packet in response to the spoofed ARP request packet from the registered computer 102, the monitoring unit 101 transmits a spoofed ARP reply packet to the unregistered computer 103. Accordingly, the monitoring unit 101 can exclude accesses (responses) from the registered computer 102 to the unregistered computer 103 with no waiting time. In response to the reception of an ARP reply packet for the spoofed ARP request packet from the registered computer 102, the monitoring unit 101 transmits a spoofed ARP reply packet to the unregistered computer 103, thereby enabling the unregistered computer 103 to receive the spoofed ARP reply packet after an ARP reply packet from the registered computer 102 to the unregistered computer 103. Accordingly, the retransmission (retry) of a spoofed ARP reply packet due to a short waiting time which might be performed in the aforementioned method will not be performed in this embodiment. Since an ARP reply packet for a spoofed ARP request packet is used as a trigger, an extra waiting time need not be secured in the embodiment, which makes it possible to shorten the time during which the communication between the unregistered computer 103 (unauthorized computer) and the registered computer 102 takes place.

Furthermore, the spoofed ARP reply packet includes the MAC address (MAC2) of the unregistered computer 103 as the sender MAC address. That is, in the ARP table of the unregistered computer 103, a pair of addresses—the MAC address (MAC2) of the unregistered computer 103 and the IP address (IP1) of the registered computer 102—are registered. Registering the MAC address of the unregistered computer 103 itself in the ARP table prevents unauthorized packets from being sent onto the network and enables an increase in the traffic due to unauthorized packets to be suppressed. The sender MAC address in the spoofed ARP reply packet may be the MAC address (MAC0) of the monitoring unit 101. In this case, the monitoring unit 101 can monitor an unauthorized packet transmitted from the unregistered computer 103.

When having received a Gratuitous ARP packet transmitted from the unregistered computer 103, the monitoring unit 101 ignores the packet.

The Gratuitous ARP is an ARP request packet where its own IP address is set in the field of the target IP address. The Gratuitous ARP is usually used to check IP address for duplication. When an ARP request packet in which its own IP address has been set in the field of the target IP address has been broadcast, if there is no other node with duplicated IP address, there is no response to the ARP request packet. However, if there is a node with duplicated IP address, the node sends back an ARP reply packet. Accordingly, the duplication of IP address can be checked, depending on whether an ARP reply packet is sent back.

The reason why the monitoring unit 101 ignores the Gratuitous ARP packet is that, if the operating system (OS) of the unregistered computer 103 is, for example, Window Vista® or Windows® Server 2008 and is so set that it determines the IP address by the DHCP, the following problem might arise: an IP address that can be leased at a DHCP server is exhausted. When the monitoring unit 101 receives a Gratuitous ARP packet from the unregistered computer 103 and transmits a spoofed ARP request packet to the unregistered computer 103 (S13B), the unregistered computer 103 determines that the IP address now in use is invalid and requests the IP address from the DHCP server again. Accordingly, if the above process is repeated, IP addresses that can be leased at the DHCP server are exhausted. Therefore, when having received a Gratuitous ARP packet transmitted from the unregistered computer 103, the monitoring unit 101 ignores the packet.

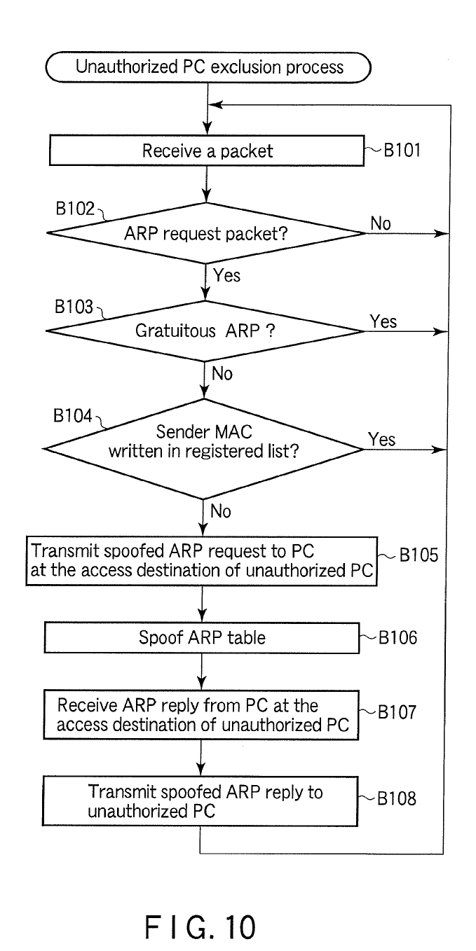

FIG. 10 is a flowchart to explain an unauthorized computer exclusion process performed by the monitoring unit 101.

First, the monitoring unit 101 receives a packet transmitted from another node (block B101). Next, the monitoring unit 101 determines whether the received packet is an ARP request packet (block B102). Whether the received packet is an ARP request packet can be determined based on the value set in the field of the protocol type in the packet or the like as described above.

If the received packet is an ARP request packet (YES in block B102), the monitoring unit 101 determines whether the received packet is a Gratuitous ARP packet (block B103). If “0” is set in the field of the sender IP address in the received packet or if the sender IP address is equal to the target IP address, it is determined that the received packet is a Gratuitous ARP packet.

If the received packet is not a Gratuitous ARP packet (NO in block B103), the monitoring unit 101 determines whether the sender MAC address in the received packet has been written in the registered list (block B104).

If the sender MAC address in the received packet has not been written in the registered list (NO in block B104), the monitoring unit 101 determines that the computer which transmitted the received packet is an unauthorized computer and transmits a spoofed ARP request packet to the computer which the unauthorized computer accesses (block B105). The monitoring unit 101 spoofs its own ARP table (block B106).

Next, the monitoring unit 101 receives an ARP reply packet from the computer which the unauthorized computer accesses (block B107). Then, the monitoring unit 101 transmits a spoofed ARP reply packet to the unauthorized computer (block B108).

By the above processes, the monitoring unit 101 can exclude accesses from the unauthorized computer to another computer and accesses from another computer to the unauthorized computer.

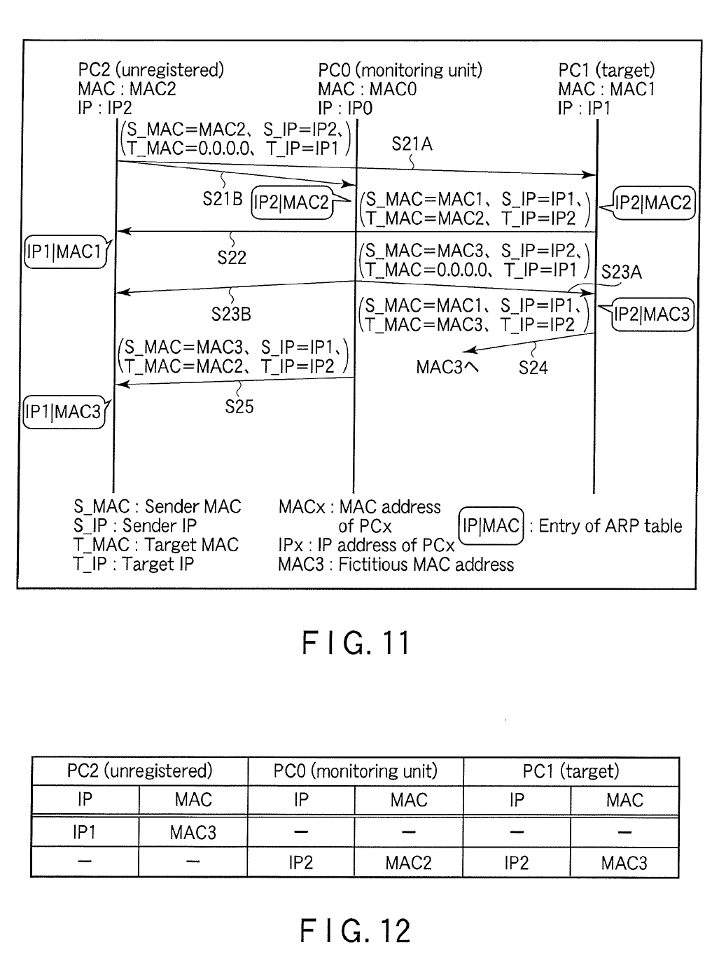

FIG. 11 is a sequence diagram showing another example of how the monitoring unit 101 functioning as the network monitoring apparatus of the embodiment excludes unauthorized accesses. As in the sequence diagram of FIG. 8, suppose the monitoring unit 101 excludes an unauthorized access from the unregistered computer 103 (an unauthorized computer) to the registered computer 102. Let the MAC address of the monitoring unit 101 be MAC0, the IP address of the monitoring unit 101 be IP0, the MAC address of the registered computer 102 be MAC1, the IP address of the registered computer 102 be IP1, the MAC address of the unregistered computer 103 be MAC2, and the IP address of the unregistered computer 103 be IP2. In addition, let MAC3 be a fictitious MAC address not allocated to any node.

First, the unregistered computer 103 broadcasts an ARP request packet to inquire about the MAC address of the registered computer 102 at the access destination (target) (S21A, S21B). Because of transmission by broadcast, both the monitoring unit 101 and registered computer 102 receive an ARP request packet. The ARP request packet includes the sender MAC address representing the MAC address (MAC2) of the unregistered computer 103, the sender IP address representing the IP address (IP2) of the unregistered computer 103, the target MAC address representing “0” to inquire about the MAC address of the registered computer 102, and the target IP address representing the IP address (IP1) of the registered computer 102. Each of the monitoring unit 101 and registered computer 102 registers a pair of the IP address (IP2) and MAC address (MAC2) of the unregistered computer 103 in the corresponding ARP table.

Having received the ARP request packet, the registered computer 102 to which the broadcast ARP request packet is addressed unicasts an ARP reply packet to the unregistered computer 103 (S22). The ARP reply packet includes the sender MAC address representing the MAC address (MAC1) of the registered computer 102, the sender IP address representing the IP address (IP1) of the registered computer 102, the target MAC address representing the MAC address (MAC2) of the unregistered computer 103, and the target IP address representing the IP address (IP2) of the unregistered computer 103. Because of transmission by unicast, only the unregistered computer 103 receives the ARP reply packet and the monitoring unit 101 cannot receive the ARP reply packet. The unregistered computer 103 registers a pair of the IP address (IP1) and MAC address (MAC1) of the registered computer 102 in the ARP table. This makes it possible to exchange packets between the unregistered computer 103 and registered computer 102.

Then, to rewrite the IP address (IP2) and MAC address (MAC2) of the unregistered computer 103 registered in the ARP table of the registered computer 102, the monitoring unit 101 broadcasts a spoofed ARP request packet where the MAC address of the unregistered computer 103 is spoofed as a fictitious MAC address (S23A, S23B). Accordingly, the spoofed ARP request packet includes the sender MAC address representing a fictitious MAC address (MAC3), the sender IP address representing the IP address (IP2) of the unregistered computer 103, the target MAC address representing “0” to inquire about the MAC address of the registered computer 102, and the target IP address representing the IP address (IP1) of the registered computer 102. Because of transmission by broadcast, the unregistered computer 103 and registered computer 102 both receive the spoofed ARP request packet. However, since the unregistered computer 103 is not the destination of the spoofed ARP request packet, it ignores the packet. The registered computer 102 registers a pair of the IP address (IP2) of the unregistered computer 103 and the fictitious MAC address (MAC3) in the ARP table. This makes it possible to block the transmission of packets from the registered computer 102 to the unregistered computer 103.

Having received the spoofed ARP request packet, the registered computer 102 unicasts an ARP reply packet to a fictitious computer (S24). The ARP reply packet includes the sender MAC address representing the MAC address (MAC1) of the registered computer 102, the sender IP address representing the IP address (IP1) of the registered computer 102, the target MAC address representing a fictitious MAC address (MAC3), and the target IP address representing the IP address (IP2) of the unregistered computer 103. Since the target MAC address is spoofed as the fictitious MAC address (MAC3), the ARP reply packet is transmitted to the fictitious computer and is not received by the unregistered computer 103.

After a specific length of time (e.g., 5 seconds) has passed since the monitoring unit 101 received the ARP request packet from the unregistered computer 103 (S21B), the monitoring unit 101 unitcasts a spoofed ARP reply packet where the MAC address of the registered computer 102 is spoofed as MAC3 (the fictitious MAC address) (S25). Accordingly, the spoofed ARP reply packet includes the sender MAC address representing the fictitious MAC address (MAC3), the sender IP address representing the IP address (IP1) of the registered computer 102, the target MAC address representing the MAC address (MAC2) of the unregistered computer 103, and the target IP address representing the IP address (IP2) of the unregistered computer 103. The unregistered computer 103 registers a pair of the IP address (IP1) of the registered computer 102 and the fictitious MAC address (MAC3) in the ARP table. This makes it possible to block the transmission of packets from the unregistered computer 103 to the registered computer 102.

As a result of the aforementioned processes, the ARP table of each node is written as shown in FIG. 12.

In the ARP table of the unregistered computer 103, a pair of the IP address (IP1) of the registered computer 102 and the fictitious MAC address (MAC3) is registered. In the ARP table of the monitoring unit 101, a pair of the IP address (IP2) and MAC address (MAC2) of the unregistered computer 103 is registered. In the ARP table of the registered computer 102, a pair of the IP address (IP2) of the unregistered computer 103 and the fictitious MAC address (MAC3) is registered.

Writing the ARP table of each node as described above makes it possible to block the transmission of packets from the unregistered computer 103 to the registered computer 102 and the transmission of packets from the registered computer 102 to the unregistered computer 103.

Moreover, since unauthorized accesses are excluded using fictitious MAC addresses, the processes are simplified.

The spoofed ARP reply packet (S25) may be a spoofed ARP request packet. The spoofed ARP request packet includes the sender MAC address representing the fictitious MAC address (MAC3), the sender IP address representing IP address (IP1) of the registered computer 102, the target MAC address representing “0” to inquire about the MAC address of the unregistered computer 103, and the target IP address representing the IP address (IP2) of the unregistered computer 103. When the spoofed ARP request packet has been transmitted to the unregistered computer 103, the unregistered computer 103 transmits an ARP reply packet in response to the spoofed ARP request packet. Therefore, there is a possibility that an unnecessary packet will be sent onto the network.

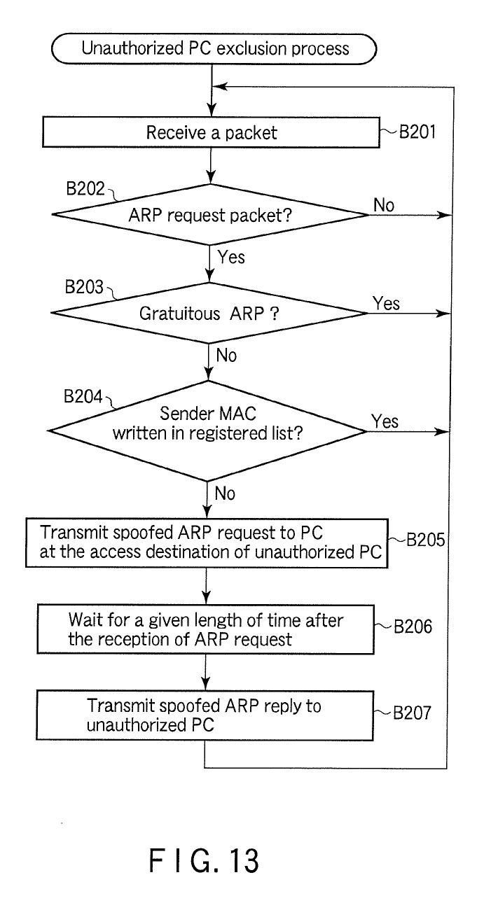

FIG. 13 is a flowchart to explain another procedure for the unauthorized computer exclusion process performed by the monitoring unit 101.

First, the monitoring unit 101 receives a packet transmitted from another node (block B201). Next, the monitoring unit 101 determines whether the received packet is an ARP request packet (block B202). Whether the received packet is an ARP request packet can be determined based on the value set in the field of the protocol type in the packet or the like as described above.

If the received packet is an ARP request packet (YES in block B202), the monitoring unit 101 determines whether the received packet is a Gratuitous ARP packet (block B203). If “0” is set in the field of the sender IP address in the received packet or if the sender IP address is equal to the target IP address, it is determined that the received packet is a Gratuitous ARP packet.

If the received packet is not a Gratuitous ARP packet (NO in block B203), the monitoring unit 101 determines whether the sender MAC address in the received packet has been written in the registered list (block B204).

If the sender MAC address in the received packet has not been written in the registered list (NO in block B204), the monitoring unit 101 determines that the computer which transmitted the received packet is an unauthorized computer and transmits a spoofed ARP request packet to the computer which the unauthorized computer accesses (block B205).

Then, the monitoring unit 101 receives an ARP request packet from the unauthorized computer and waits for the process to be executed until a specific period of time has elapsed (block B206). When a specific period of time has elapsed since the monitoring unit 101 received the ARP request packet from the unauthorized computer, the monitoring unit 101 transmits a spoofed ARP reply packet to the unauthorized computer (block B207).

By the above processes, the monitoring unit 101 can exclude accesses from the unauthorized computer to another computer and accesses from another computer to the unauthorized computer.

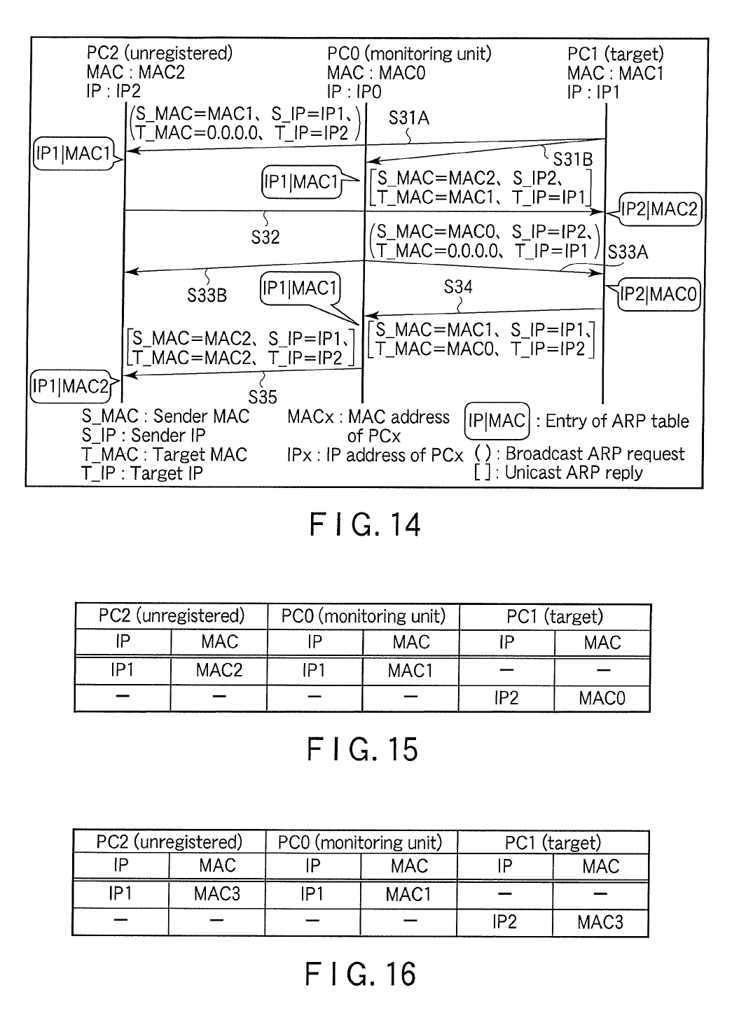

FIG. 14 is a sequence diagram showing another example of how the monitoring unit 101 functioning as the network monitoring apparatus of the embodiment excludes unauthorized accesses. Here, suppose the monitoring unit 101 excludes an unauthorized access from the registered computer 102 to the unregistered computer 103, an unauthorized computer. Let the MAC address of the monitoring unit 101 be MAC0, the IP address of the monitoring unit 101 be IP0, the MAC address of the registered computer 102 be MAC1, the IP address of the registered computer 102 be IP1, the MAC address of the unregistered computer 103 be MAC2, and the IP address of the unregistered computer 103 be IP2.

First, the registered computer 102 broadcasts an ARP request packet to inquire about the MAC address of the unregistered computer 103 at the access destination (S31A, S31B). Because of transmission by broadcast, both the monitoring unit 101 and unregistered computer 103 receive an ARP request packet. The ARP request packet includes the sender MAC address representing the MAC address (MAC1) of the registered computer 102, the sender IP address representing the IP address (IP1) of the registered computer 102, the target MAC address representing “0” to inquire about the MAC address of the unregistered computer 103, and the target IP address representing the IP address (IP2) of the unregistered computer 103. Each of the monitoring unit 101 and unregistered computer 103 registers a pair of the IP address (IP1) and MAC address (MAC1) of the registered computer 102 in the corresponding ARP table.

Having received the ARP request packet, the unregistered computer 103 to which the broadcast ARP request packet is addressed unicasts an ARP reply packet to the registered computer 102 (S32). The ARP reply packet includes the sender MAC address representing the MAC address (MAC2) of the unregistered computer 103, the sender IP address representing the IP address (IP2) of the unregistered computer 103, the target MAC address representing the MAC address (MAC1) of the registered computer 102, and the target IP address representing the IP address (IP1) of the registered computer 102. Because of transmission by unicast, only the registered computer 102 receives the ARP reply packet and the monitoring unit 101 cannot receive the ARP reply packet. The registered computer 102 registers a pair of the IP address (IP2) and MAC address (MAC2) of the unregistered computer 103 in the ARP table. This makes it possible to exchange packets between the unregistered computer 103 and registered computer 102.

The monitoring unit 101 receives the ARP request packet broadcast from the registered computer 102 (S31B) and determines whether the unregistered computer 103 at the destination of the ARP request packet is an unauthorized computer. Specifically, the monitoring unit 101 determines whether the target IP address (IP2) in the ARP request packet has been written in the detection list. If the target IP address (IP2) in the ARP request packet has been written in the detection list, the monitoring unit 101 retrieves the MAC address (MAC2) corresponding to the target IP address (IP2) in the detection list. Then, if the target IP address has been written in the detection list, the monitoring unit 101 carries out the following processes to exclude an unauthorized access from the unregistered computer 103.

To rewrite the IP address (IP2) and MAC address (MAC2) of the unregistered computer 103 registered in the ARP table of the registered computer 102, the monitoring unit 101 broadcasts a spoofed ARP request packet where the MAC address of the unregistered computer 103 has been spoofed as the MAC address of the monitoring unit 101 (S33A, S33B). Accordingly, the spoofed ARP request packet includes the sender MAC address representing the MAC address (MAC0) of the monitoring unit 101, the sender IP address representing the IP address (IP2) of the unregistered computer 103, the target MAC address representing “0” to inquire about the MAC address of the registered computer 102, and the target IP address representing the IP address (IP1) of the registered computer 102. Because of transmission by broadcast, the unregistered computer 103 and registered computer 102 both receive the spoofed ARP request packet. However, since the unregistered computer 103 is not the destination of the spoofed ARP request packet, it ignores the packet. The registered computer 102 registers a pair of the IP address (IP2) of the unregistered computer 103 and the MAC address (MAC0) of the monitoring unit 101 in the ARP table. This makes it possible to block the transmission of packets from the registered computer 102 to the unregistered computer 103.

Having received the spoofed ARP request packet, the registered computer 102 unicasts an ARP reply packet to the monitoring unit 101 (S34). The ARP reply packet includes the sender MAC address representing the MAC address (MAC1) of the registered computer 102, the sender IP address representing the IP address (IP1) of the registered computer 102, the target MAC address representing the MAC address (MAC0) of the monitoring unit 101, and the target IP address representing the IP address (IP2) of the unregistered computer 103. The monitoring computer 101 registers a pair of the IP address (IP1) and MAC address (MAC1) of the registered computer 102 in the ARP table.

When having received the ARP reply packet from the registered computer 102, the monitoring unit 101 determines that the unregistered computer 103 has transmitted a normal ARP reply packet (S32) to the registered computer 102. Then, the monitoring unit 101 unicasts a spoofed ARP reply packet where the MAC address of the registered computer 102 has been spoofed as MAC2 (the MAC address of the unregistered computer 103) (S35). Accordingly, the spoofed ARP reply packet includes the sender MAC address representing the MAC address (MAC2) of the unregistered computer 103, the sender IP address representing the IP address (IP1) of the registered computer 102, the target MAC address representing the MAC address (MAC2) of the unregistered computer 103, and the target IP address representing the IP address (IP2) of the unregistered computer 103. The unregistered computer 103 registers a pair of the IP address (IP1) of the registered computer 102 and the MAC address (MAC2) of the unregistered computer 103 in the ARP table. This makes it possible to block the transmission of packets from the unregistered computer 103 to the registered computer 102.

As a result of the aforementioned processes, the ARP table of each node is written as shown in FIG. 15.

In the ARP table of the unregistered computer 103, a pair of the IP address (IP1) of the registered computer 102 and the MAC address (MAC2) of the unregistered computer 103 is registered. In the ARP table of the monitoring unit 101, a pair of the IP address (IP1) and MAC address (MAC1) of the registered computer 102 is registered. In the ARP table of the registered computer 102, a pair of the IP address (IP2) of the unregistered computer 103 and the MAC address (MAC0) of the monitoring unit 101 is registered.

Writing the ARP table of each node as described above makes it possible to block the transmission of packets from the unregistered computer 103 to the registered computer 102 and the transmission of packets from the registered computer 102 to the unregistered computer 103.

In the process of excluding an unauthorized access from the registered computer 102 to the unregistered computer 103, a fictitious MAC address (MAC3) not allocated to any node can be used as in the sequence diagram of FIG. 11.

Furthermore, the spoofed ARP reply packet (S35) may be a spoofed ARP request packet. The spoofed ARP request packet includes the sender MAC address representing the MAC address (MAC2) of the unregistered computer 103, the sender IP address representing the IP address (IP1) of the registered computer 102, the target MAC address representing “0” to inquire about the MAC address of the unregistered computer 103, and the target IP address representing the IP address (IP2) of the unregistered computer 103. When the spoofed ARP request packet has been transmitted to the unregistered computer 103, there is a possibility that an unnecessary packet will be sent onto the network since the unregistered computer 103 transmits an ARP reply packet in response to the spoofed ARP request packet.

When a fictitious MAC address is used in the process of excluding an unauthorized access from the registered computer 102 to the unregistered computer 103, the ARP table of each node is written as shown in FIG. 16.

In the ARP table of the unregistered computer 103, a pair of the IP address (IP1) of the registered computer 102 and a fictitious MAC address (MAC3) is registered. In the ARP table of the monitoring unit 101, a pair of the IP address (IP1) of the registered computer 102 and the MAC address (MAC1) of the registered computer 102 is registered. In the ARP table of the registered computer 102, a pair of the IP address (IP2) of the unregistered computer 103 and a fictitious MAC address (MACS) is registered.

Writing the ARP table of each node as described above makes it possible to block the transmission of packets from the unregistered computer 103 to the registered computer 102 and the transmission of packets from the registered computer 102 to the unregistered computer 103.

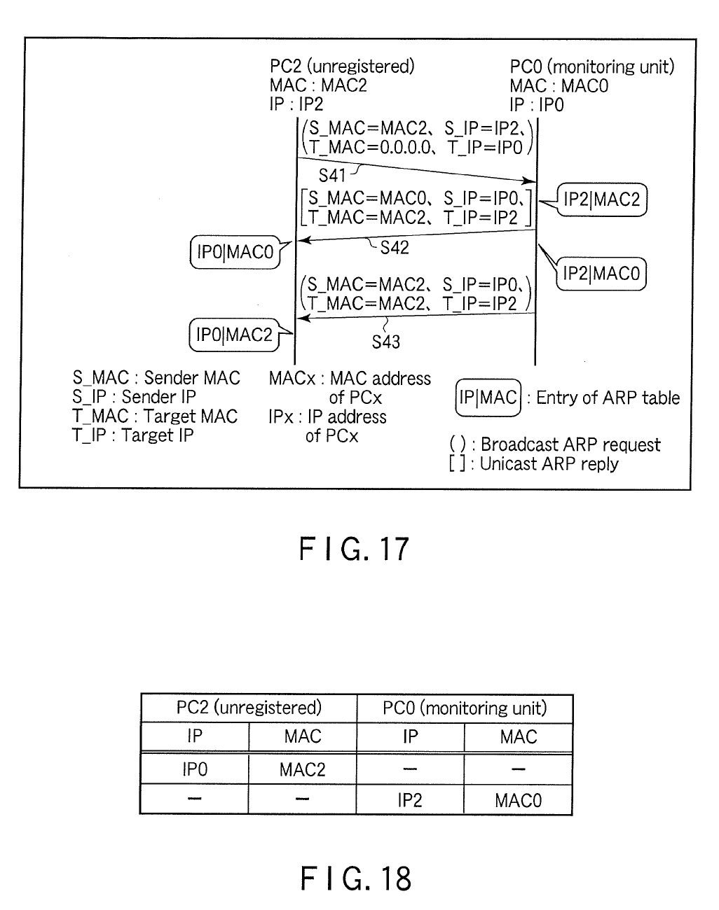

FIG. 17 is a sequence diagram showing another example of how the monitoring unit 101 functioning as the network monitoring apparatus of the embodiment excludes unauthorized accesses. Here, suppose the monitoring unit 101 excludes an unauthorized access from the unregistered computer 103, an unauthorized computer, to the monitoring unit 101. Let the MAC address of the monitoring unit 101 be MAC0, the IP address of the monitoring unit 101 be IP0, the MAC address of the unregistered computer 103 be MAC2, and the IP address of the unregistered computer 103 be IP2.

First, the unregistered computer 103 broadcasts an ARP request packet to inquire about the MAC address of the monitoring unit 101 at the access destination (target) (S41). The ARP request packet includes the sender MAC address representing the MAC address (MAC2) of the unregistered computer 103, the sender IP address representing the IP address (IP2) of the unregistered computer 103, the target MAC address representing “0” to inquire about the MAC address of the monitoring unit 101, and the target IP address representing the IP address (IP0) of the monitoring unit 101. The monitoring unit 101 registers a pair of the IP address (IP2) and MAC address (MAC2) of the unregistered computer 103 in the ARP table.

Having received the ARP request packet, the monitoring unit 101 to which the broadcast ARP request packet is addressed unicasts an ARP reply packet to the unregistered computer 103 (S42). The ARP reply packet includes the sender MAC address representing the MAC address (MAC0) of the monitoring unit 101, the sender IP address representing the IP address (IP0) of the monitoring unit 101, the target MAC address representing the MAC address (MAC2) of the unregistered computer 103, and the target IP address representing the IP address (IP2) of the unregistered computer 103. The unregistered computer 103 registers a pair of the IP address (IP0) and MAC address (MAC0) of the monitoring unit 101 in the ARP table. This makes it possible to exchange packets between the unregistered computer 103 and monitoring unit 101.

Furthermore, the monitoring unit 101 spoofs its own ARP table by rewriting a pair of the IP address (IP2) and MAC address (MC2) of the unregistered computer 103 registered in the ARP table. The monitoring unit 101 registers a pair of the IP address (IP2) of the unregistered computer 103 and the MAC address (MAC0) of the monitoring unit 101.

Then, the monitoring unit 101 unicasts to the unregistered computer 103 a spoofed ARP reply packet where the MAC address of the monitoring unit 101 is spoofed as MAC2 (the MAC address of the unregistered computer 103) (S43). Accordingly, the spoofed ARP reply packet includes the sender MAC address representing the MAC address (MAC2) of the unregistered computer 103, the sender IP address representing the IP address (IP0) of the monitoring unit 101, the target MAC address representing the MAC address (MAC2) of the unregistered computer 103, and the target IP address representing the IP address (IP2) of the unregistered computer 103. The unregistered computer 103 registers a pair of the IP address (IP0) of the monitoring unit 101 and the MAC address (MAC2) of the unregistered computer 103. This makes it possible to block the transmission of packets from the unregistered computer 103 to the monitoring unit 101.

As a result of the aforementioned processes, the ARP table of each node is written as shown in FIG. 18.

In the ARP table of the unregistered computer 103, a pair of the IP address (IP0) of the monitoring unit 101 and the MAC address (MAC2) of the unregistered computer 103 is registered. In the ARP table of the monitoring unit 101, a pair of the IP address (IP2) of the unregistered computer 103 and the MAC address (MAC0) of the monitoring unit 101 is registered.

Writing the ARP table of each node as described above makes it possible to block the transmission of packets from the unregistered computer 103 to the monitoring unit 101 and the transmission of packets from the monitoring unit 101 to the unregistered computer 103.

The transmission of a spoofed ARP reply packet from the monitoring unit 101 to the unregistered computer 103 (S43) is performed immediately after the transmission of an ARP reply packet from the monitoring unit 101 to the unregistered computer 103 (S42). This makes it possible to make very short the time during which the communication between the monitoring unit 101 and the unregistered computer 103 can be performed.

In the process of excluding an unauthorized access from the unregistered computer 103, a fictitious MAC address not allocated to any node can be used as in the sequence diagram of FIG. 11.

Furthermore, the spoofed ARP reply packet (S43) may be a spoofed ARP request packet. The spoofed ARP request packet includes the sender MAC address representing the MAC address (MAC2) of the unregistered computer 103, the sender IP address representing the IP address (IP0) of the monitoring unit 101, the target MAC address representing “0” to inquire about the MAC address of the unregistered computer 103, and the target IP address representing the IP address (IP2) of the unregistered computer 103. When the spoofed ARP request packet has been transmitted to the unregistered computer 103, there is a possibility that an unnecessary packet will be sent onto the network since the unregistered computer 103 transmits an ARP reply packet in response to the spoofed ARP request packet.

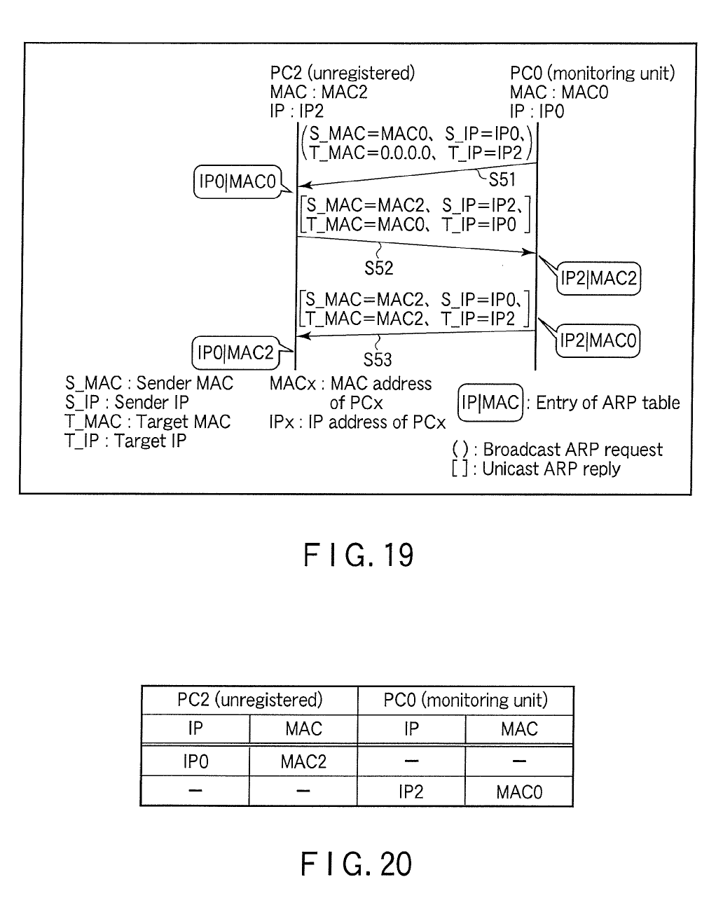

FIG. 19 is a sequence diagram showing another example of how the monitoring unit 101 functioning as the network monitoring apparatus of the embodiment excludes unauthorized accesses. Here, suppose the monitoring unit 101 excludes an unauthorized access from the monitoring unit 101 to the unregistered computer 103, an unauthorized computer. This is, for example, the process executed by a module in the monitoring unit 101 with the unauthorized computer exclusion function of the embodiment by the OS or an application program on the monitoring unit 101 when the unregistered computer 103 has been performed an unauthorized access. Let the MAC address of the monitoring unit 101 be MAC0, the IP address of the monitoring unit 101 be IP0, the MAC address of the unregistered computer 103 be MAC2, and the IP address of the unregistered computer 103 be IP2.

First, the monitoring unit 101 broadcasts an ARP request packet to inquire about the MAC address of the unregistered computer 103 at the access destination (S51). The ARP request packet includes the sender MAC address representing the MAC address (MAC0) of the monitoring unit 101, the sender IP address representing the IP address (IP0) of the monitoring unit 101, the target MAC address representing “0” to inquire about the MAC address of the unregistered computer 103, and the target IP address representing the IP address (IP2) of the unregistered computer 103. The unregistered computer 103 registers a pair of the IP address (IP0) and MAC address (MAC0) of the monitoring unit 101 in the ARP table.

Having received the ARP request packet, the unregistered computer 103 to which the broadcast ARP request packet is addressed unicasts an ARP reply packet to the monitoring unit 101 (S52). The ARP reply packet includes the sender MAC address representing the MAC address (MAC2) of the unregistered computer 103, the sender IP address representing the IP address (IP2) of the unregistered computer 103, the target MAC address representing the MAC address (MAC0) of the monitoring unit 101, and the target IP address representing the IP address (IP0) of the monitoring unit 101. The monitoring unit 101 registers a pair of the IP address (IP2) and MAC address (MAC2) of the unregistered computer 103 in the ARP table. This makes it possible to exchange packets between the unregistered computer 103 and monitoring unit 101.

The monitoring unit 101 determines whether the unregistered computer 103 to which the broadcast ARP request packet has been addressed is an unauthorized computer. Specifically, the monitoring unit 101 determines whether the target IP address (IP2) in the ARP request packet has been written in the detection list. If the target IP address (IP2) in the ARP request packet has been written in the detection list, the monitoring unit 101 retrieves an MAC address (MAC2) corresponding to the target IP address (IP2) in the detection list. If the target IP address (IP2) has been written in the detection list, the monitoring unit 101 carries out the following processes to exclude an unauthorized access from the unregistered computer 103.

The monitoring unit 101 spoofs its own ARP table by rewriting a pair of the IP address (IP2) and MAC address (MC2) of the unregistered computer 103 registered in the ARP table. The monitoring unit 101 registers a pair of the IP address (IP2) of the unregistered computer 103 and the MAC address (MAC0) of the monitoring unit 101.

Then, the monitoring unit 101 unicasts to the unregistered computer 103 a spoofed ARP reply packet where the MAC address of the monitoring unit 101 is spoofed as MAC2 (the MAC address of the unregistered computer 103) (S53). Accordingly, the spoofed ARP reply packet includes the sender MAC address representing the MAC address (MAC2) of the unregistered computer 103, the sender IP address representing the IP address (IP0) of the monitoring unit 101, the target MAC address representing the MAC address (MAC2) of the unregistered computer 103, and the target IP address representing the IP address (IP2) of the unregistered computer 103. The unregistered computer 103 registers a pair of the IP address of the monitoring unit 101 and the MAC address (MAC2) of the unregistered computer 103. This makes it possible to block the transmission of packets from the unregistered computer 103 to the monitoring unit 101.

As a result of the aforementioned processes, the ARP table of each node is written as shown in FIG. 18.

In the ARP table of the unregistered computer 103, a pair of the IP address (IP0) of the monitoring unit 101 and the MAC address (MAC2) of the unregistered computer 103 is registered. In the ARP table of the monitoring unit 101, a pair of the IP address (IP2) of the unregistered computer 103 and the MAC address (MAC0) of the monitoring unit 101 is registered.

Writing the ARP table of each node as described above makes it possible to block the transmission of packets from the unregistered computer 103 to the monitoring unit 101 and the transmission of packets from the monitoring unit 101 to the unregistered computer 103.

The transmission of a spoofed ARP reply packet from the monitoring unit 101 to the unregistered computer 103 (S53) is performed immediately after the transmission of an ARP reply packet from the unregistered computer 103 to the monitoring unit (S52). This makes it possible to make very short the time during which the communication between the monitoring unit 101 and the unregistered computer 103 can be performed.

In the process of excluding an unauthorized access from the unregistered computer 103, a fictitious MAC address not allocated to any node can be used as in the sequence diagram of FIG. 11.

Furthermore, the spoofed ARP reply packet (S53) may be a spoofed ARP request packet. The spoofed ARP request packet includes the sender MAC address representing the MAC address (MAC2) of the unregistered computer 103, the sender IP address representing the IP address (IP0) of the monitoring unit 101, the target MAC address representing “0” to inquire about the MAC address of the unregistered computer 103, and the target IP address representing the IP address (IP2) of the unregistered computer 103. When the spoofed ARP request packet is transmitted to the unregistered computer 103, there is a possibility that an unnecessary packet will be sent onto the network since the unregistered computer 103 transmits an ARP reply packet in response to the spoofed ARP request packet.

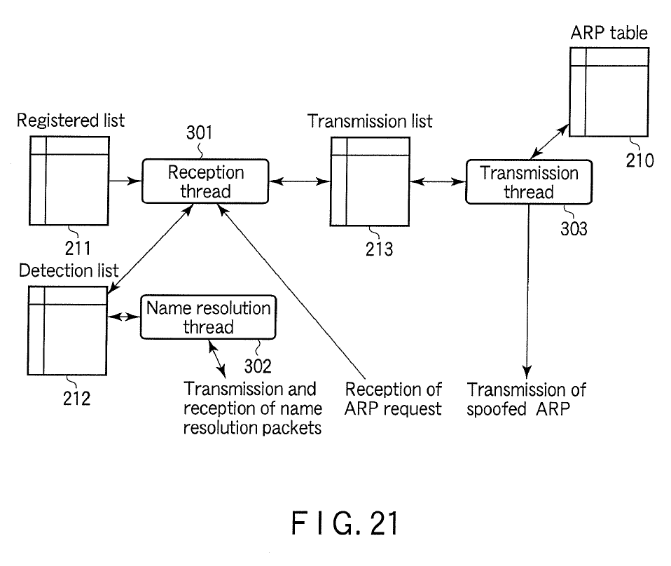

FIG. 21 is a block diagram showing an example of realizing the function of the monitoring unit 101 using multithreads. The monitoring unit 101 holds an ARP table stored in the ARP table storage module 210, a registered list stored in the registered list storage module 211, a detection list stored in the detection list storage module 212, and a transmission list stored in the transmission list storage module 213. Using a reception thread 301, a name resolution thread 302, and a transmission thread 303, the monitoring unit 101 performs the process of monitoring and excluding an access from an unauthorized node.

The reception thread 301 receives an ARP request packet transmitted from another node and determines whether the node which transmitted the ARP request packet is an unauthorized node, referring to the registered list. Moreover, referring to the detection list and registered list, the reception thread 301 determines whether the destination of the ARP request packet is an unauthorized node.

If the node which transmitted the ARP request packet is an unauthorized node or if the destination of the ARP request packet is an unauthorized node, the reception thread 301 adds to the top of the transmission list an entry in which information necessary to transmit blocking packets (a spoofed ARP request packet and spoofed ARP reply packet) has been written. The entry added to the transmission list includes the sender MAC address, sender IP address, target MAC address, and target IP address in the received ARP request packet, and a reception time, and a request transmission flag as described with reference to FIG. 7. The entries in the transmission list are processed, beginning with the top of the transmission list. Accordingly, adding an entry to the top of the transmission list causes a blocking packet based on the contents of the entry to be given priority over other packets in transmission. This makes it possible to exclude accesses from unauthorized computers even if the number of unauthorized computers is large.

If the sender MAC address in the received ARP request packet has not been written in the registered list and detection list, the reception thread 301 registers a pair of the IP address and MAC address in the received ARP request packet in the detection list. If the IP address has been written in the detection list, the MAC address corresponding to the IP address is overwritten with the MAC address in the received ARP request packet.

The name resolution thread 302 searches the detection list and sets a host name by name resolution in an entry in which no host name has been written. Specifically, the name resolution thread 302 searches the detection list and reads an entry in which no host name has been written. Then, based on the IP address written in the read entry, the name resolution thread 302 transmits and receives a name resolution packet for name resolution by, for example, DNS or NetBIOS. If name resolution has succeeded, the name resolution thread 302 writes the received name in the host name field of the read entry.

The transmission thread 303 reads the entries registered in the transmission, beginning with the top, and generates a spoofed ARP request packet and a spoofed ARP reply packet according to the content written in the read entry, and transmits the packets. The spoofed ARP request packet includes the sender MAC address representing the MAC address of the monitoring unit 101 or a fictitious MAC address, the sender IP address representing the sender IP address written in the read entry, the target MAC address representing the target MAC address written in the read entry, and the target IP address representing the target IP address written in the read entry. The spoofed ARP reply packet includes the sender MAC address written in the read entry or the sender MAC address representing a fictitious MAC address, the sender IP address representing the target IP address written in the read entry, the target MAC address representing the sender MAC address written in the read entry, and the target IP address representing the sender IP address written in the read entry.

The transmission thread 303 spoofs the ARP table held in the monitoring unit 101. Specifically, when a pair of the sender IP address and sender MAC address written in the entry read from the transmission list have been written in the ARP table, the transmission thread 303 replaces the MAC address with the MAC address of the monitoring unit 101 or a fictitious MAC address.

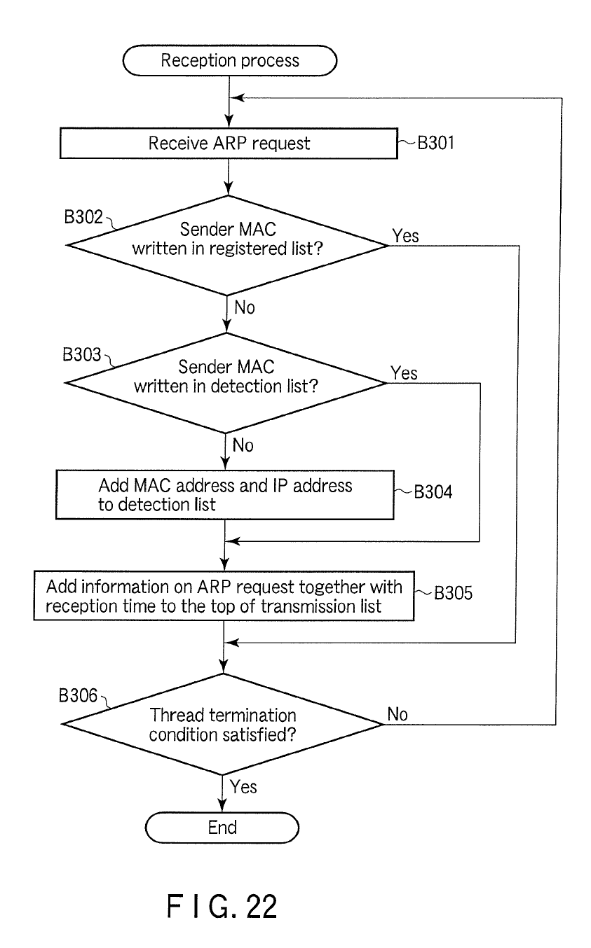

FIG. 22 is a flowchart to explain the procedure for a reception process using the reception thread 301.

First, the reception thread 301 receives an ARP request packet transmitted from another node (block B301). Next, the reception thread 301 determines whether the sender MAC address in the received ARP request packet has been written in the registered list (block B302).

If the sender MAC address in the received ARP request packet has not been written in the registered list (NO in block B302), the reception thread 301 determines whether the sender MAC address in the received ARP request packet has been written in the detection list (block B303).

If the sender MAC address in the received ARP request packet has not been written in the detection list (NO in block B303), the reception thread 301 registers a pair of the sender IP address and sender MAC address in the ARP request packet (block B304). Then, the reception thread 301 adds to the top of the transmission list an entry in which the information in the received ARP request packet have been written together with the reception time (block B305).

Next, the reception thread 301 determines whether it satisfies a thread termination condition (block B306). If the reception thread 301 satisfies the thread termination condition (YES in block B306), the reception thread 301 terminates the reception process. If the reception thread 301 dose not satisfy the thread termination condition (NO in block B306), the reception thread 301 carries out the processes again, starting with block B301.

By the above-described processes, the reception thread 301 can detect an ARP request packet from an unauthorized node and register information necessary to exclude an access from an unauthorized node and an access to an unauthorized node in the transmission list.

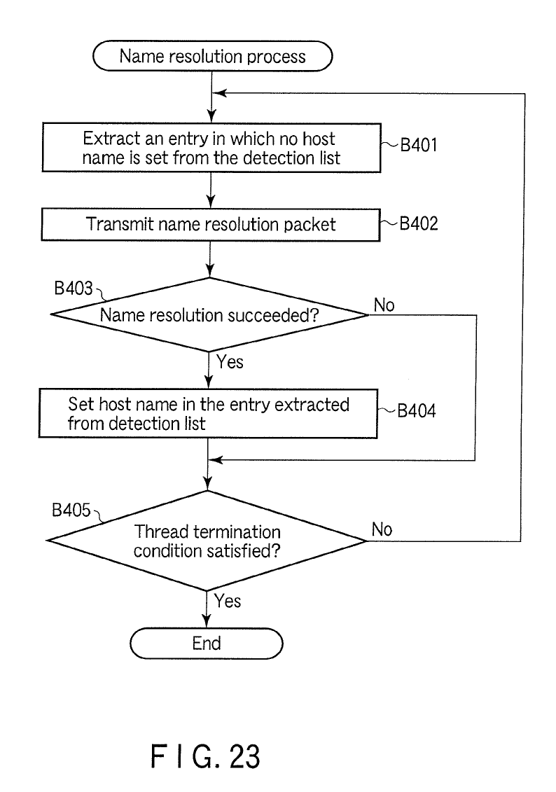

FIG. 23 is a flowchart to explain the procedure for a name resolution process performed by the name resolution thread 302.

First, the name resolution thread 302 reads an entry in which no host name has been written from the detection list (block B401). Based on the IP address written in the read entry, the name resolution thread 302 transmits a name resolution packet which requests name resolution to a DNS server or the like (block B402). The name resolution thread 302 receives a reply packet in response to the name resolution packet and determines whether name resolution has succeeded (block B403).

If the name resolution has succeeded (YES in block B403), the name resolution thread 302 sets the name obtained by name resolution in the host name field of the read entry (block B404). Based on the entry in which the host name has been set, the detection list is updated.

Next, the name resolution thread 302 determines whether it satisfies a thread termination condition (block B405). If the name resolution thread 302 satisfies the thread termination condition (YES in block B405), the name resolution thread 302 terminates the name resolution process. If the name resolution thread 302 dose not satisfy the thread termination condition (NO in block B405), the name resolution thread 302 carries out the processes again, starting with block 401.

By the above-described processes, the name resolution thread 302 can write the host name in an entry of the detection list.

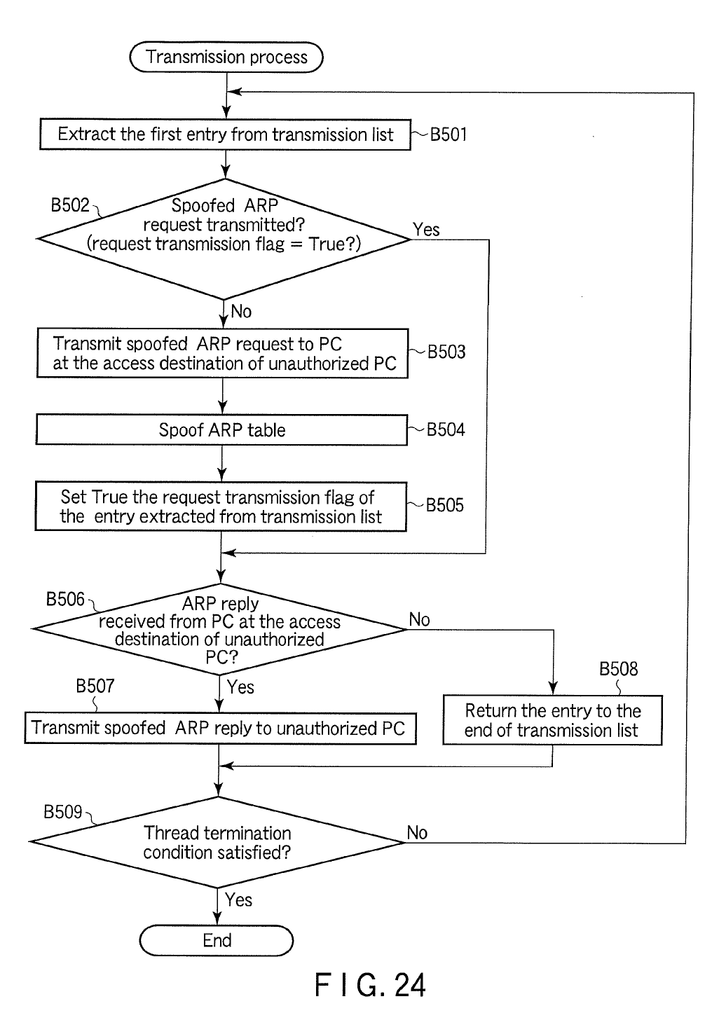

FIG. 24 is a flowchart to explain the procedure for a transmission process performed by the transmission thread 303.

First, the transmission thread 303 reads the first entry of the transmission list (block B501). Next, the transmission thread 303 determines whether a spoofed ARP request packet based on the read entry has been transmitted (block B502). That is, if a request transmission flag in the read entry is “True,” the transmission thread 303 determines that a spoofed ARP request packet has been transmitted. If the request transmission flag in the read entry is “False,” the transmission thread 303 determines that a spoofed ARP request packet has not been transmitted.

If a spoofed ARP request packet has not been transmitted (NO in block B502), the transmission thread 303 transmits a spoofed ARP request packet to a node to which an unauthorized node accesses (block B503). Then, the transmission thread 303 spoofs its own ARP table (block B504). The transmission thread 303 sets “True” in the request transmission flag field of the entry read from the transmission list (block B505).

After the process in block B505 has been performed, or when a spoofed ARP request packet has been transmitted (YES in block B502), the transmission thread 303 determines whether it has received an ARP reply packet in response to the spoofed ARP request packet from the node which the unauthorized node accesses (block B506).

If having received an ARP reply packet from the node which the unauthorized node accesses (YES in block B506), the transmission thread 303 transmits a spoofed ARP reply packet to the unauthorized node (block B507).

If not having received an ARP reply packet from the node which the unauthorized node accesses (NO in block B506), the transmission thread 303 returns the read entry to the end position of the transmission list (block B508).

Next, the transmission thread 303 determines whether it satisfies the thread termination condition (block B509). If the transmission thread 303 satisfies the thread termination condition (YES in block B509), it terminates the transmission process. If the transmission thread 303 does not satisfy the thread termination condition (NO in block B509), it executes the processes, starting with block B501.

By the above-described processes, the transmission thread 303 can perform the process of excluding an access from the unauthorized node and an access to the unauthorized node based on the entry read from the transmission list.

When a fictitious MAC address is used to exclude an unauthorized node, the monitoring unit 101 determines whether a specific length of time has elapsed since the reception time in the entry read from the transmission list in the process of block B506.

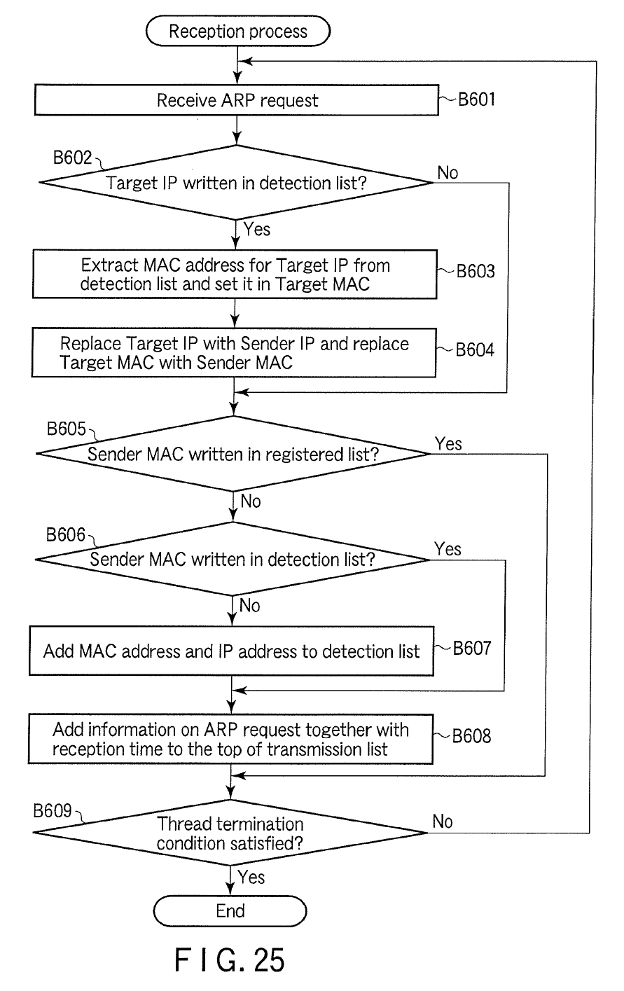

FIG. 25 is a flowchart to explain another procedure for the reception process performed by the reception thread 301. The flowchart of FIG. 25 shows a reception process performed when an ARP request packet addressed to an unauthorized node has been received.

First, the reception thread 301 receives an ARP request packet transmitted from another node (block B601). Next, the reception thread 301 determines whether the target IP address in the received ARP request packet has been written in the detection list (block B602). If the target IP address has been written in the detection list, it has been determined that the ARP request packet might be a packet addressed to the unauthorized node.

If the target IP address in the received ARP request packet has been written in the detection list (YES in block B602), the reception thread 301 extracts a MAC address corresponding to the target IP address from the detection list and sets the extracted MAC address in the target MAC address field of the received ARP request packet (block B603). Then, the reception thread 301 replaces the target IP address in the received ARP request packet with the sender IP address and further replaces the target MAC address with the sender MAC address (block B604).

After the process in block B604 is performed or if the target IP address in the received ARP request packet has not been written in the detection list (NO in block B602), the processes in subsequent blocks B605 to B609 are carried out. The processes in blocks B605 to B609 are the same as those in blocks B302 to B306 in the flowchart of FIG. 22.

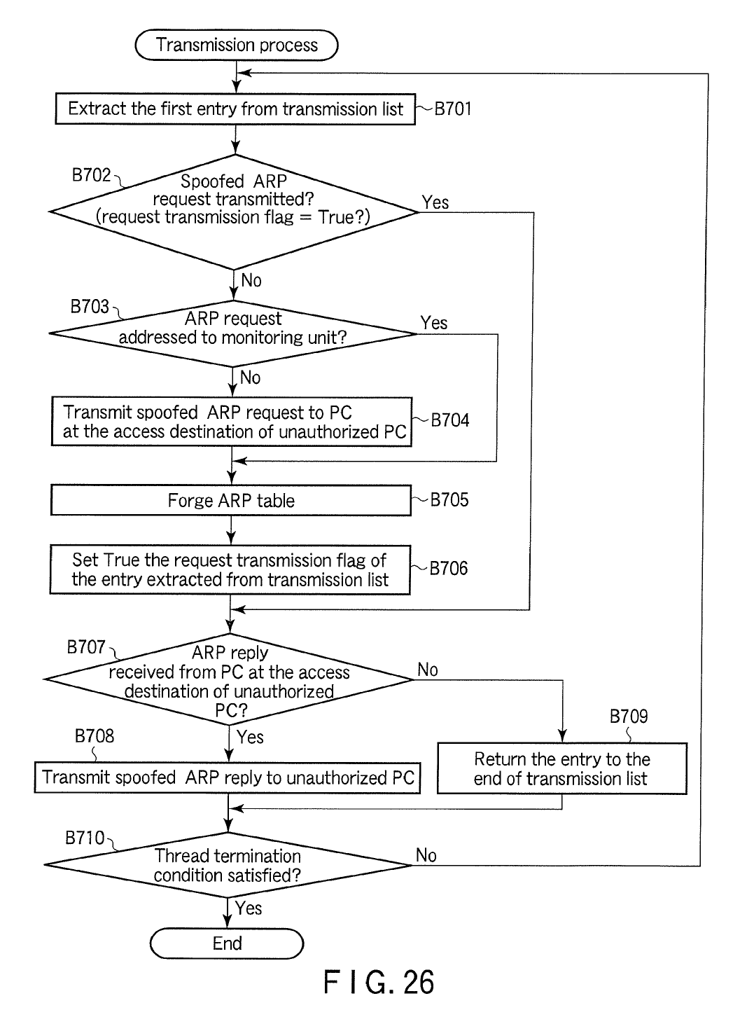

FIG. 26 is a flowchart to explain another procedure for the transmission process performed by the transmission thread 303. The flowchart of FIG. 26 shows a transmission process performed when an ARP request packet addressed to the monitoring unit 101 is transmitted from the unauthorized node.

First, the transmission thread 303 reads the first entry of the transmission list (block B701). Next, the transmission thread 303 determines whether a spoofed ARP request packet based on the read entry has been transmitted (block B702). That is, if a request transmission flag in the read entry is “True,” the transmission thread 303 determines that a spoofed ARP request packet has been transmitted. If the request transmission flag in the read entry is “False,” the transmission thread 303 determines that a spoofed ARP request packet has not been transmitted.

If a spoofed ARP request packet has not been transmitted (NO in block B702), the transmission thread 303 determines whether an ARP request packet when the read entry was created is addressed to the monitoring unit 101 (block 703). That is, the transmission thread 303 determines whether the target IP address in the read entry is the same as the IP address of the monitoring unit 101.

If an ARP request packet when the read entry was created is not addressed to the monitoring unit 101 (NO in block 703), the transmission thread 303 transmits a spoofed ARP request packet to the node which the unauthorized node accesses (block B704).

After the process in block B704 has been performed, or if an ARP request packet when the read entry was created is addressed to the monitoring unit 101 (YES in block B703), the processes in blocks B705 to B710 are carried out. The processes in blocks B705 to B710 are the same as those in blocks B504 to B509 in the flowchart of FIG. 24.

As described above, according to the embodiment, it is possible to shorten the period during which the communication between an unauthorized node and a node which the unauthorized node accesses can be performed. When having detected an ARP request packet transmitted from the unauthorized node, the monitoring unit 101 functioning as the network monitoring apparatus of the embodiment spoofs the ARP table of the monitoring unit 101, transmits a spoofed ARP request packet to the node which the unauthorized node accesses, and further transmits a spoofed ARP reply packet to the unauthorized node, thereby blocking the communication between the unauthorized node and the node which the unauthorized node accesses. The monitoring unit 101 transmits a spoofed ARP request packet to the node which the unauthorized node accesses, receives an ARP reply packet in response to the spoofed ARP request packet from the node which the unauthorized node accesses, and then transmits an ARP reply packet to the unauthorized node, thereby shortening the period during which the communication between the unauthorized node and the node which the unauthorized node accesses can be performed. Furthermore, by transmitting a spoofed ARP request packet and a spoofed ARP reply packet as described above, the ARP table of each node can be spoofed with no useless waiting time without retransmitting (retrying) a spoofed ARP reply packet.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A network monitoring apparatus which is configured to monitor a network to which nodes are connected, the network monitoring apparatus comprising:
an unauthorized node determination module configured to determine whether a sender node which transmits an address resolution protocol request packet is an unauthorized node based on a sender physical address in the address resolution protocol request packet, in response to the reception of the address resolution protocol request packet;
a spoofed address resolution protocol request transmission module configured to transmit a spoofed address resolution protocol request packet to a target node corresponding to a target network address in the received address resolution protocol request packet if the sender node is an unauthorized node, the spoofed address resolution protocol request packet including a network address of the target node as a target network address, a physical address of the network monitoring apparatus as a sender physical address and a network address of the unauthorized node as a sender network address;
an address resolution protocol reply reception module configured to receive an address resolution protocol reply packet from the target node, wherein the target node is configured to unicast the address resolution protocol reply packet to the network monitoring apparatus in response to the reception of the spoofed address resolution protocol request packet, and wherein the address resolution protocol reply packet includes the physical address of the network monitoring apparatus as a target physical address, the network address of the unauthorized node as a target network address, a physical address of the target node as a sender physical address, and the network address of the target node as a sender network address; and
a spoofed address resolution protocol reply transmission module configured to transmit a spoofed address resolution protocol reply packet to the unauthorized node in response to the reception of the address resolution protocol reply packet, the spoofed address resolution protocol reply packet including a predetermined physical address other than the physical address of the target node as a sender physical address and a network address of the target node as a sender network address.

2. The network monitoring apparatus of claim 1, wherein the spoofed address resolution protocol reply transmission module is configured to transmit a spoofed address resolution protocol reply packet to the unauthorized node in response to the reception of the address resolution protocol reply packet, the spoofed address resolution protocol reply packet including a physical address of the unauthorized node as a sender physical address and a network address of the target node as a sender network address.

3. The network monitoring apparatus of claim 1, further comprising an address resolution protocol (ARP) table spoof module configured to write the network address of the unauthorized node and the physical address of the network monitoring apparatus in association with each other into an ARP table of the network monitoring apparatus in which the correspondence between network addresses and physical addresses has been written.

4. The network monitoring apparatus of claim 1, wherein the unauthorized node determination module is configured to determine whether the target node of the address resolution protocol request packet is an unauthorized node, based on the target network address in the address resolution protocol request packet, in response to the reception of the address resolution protocol request packet and
the spoofed address resolution protocol request transmission module is configured to transmit a spoofed address resolution protocol request packet to the sender node of the received address resolution protocol request packet if the target node is an unauthorized node, the spoofed address resolution protocol request packet including the physical address of the network monitoring apparatus as a sender physical address and the network address of the unauthorized node as a sender network address.

5. The network monitoring apparatus of claim 1, wherein the unauthorized node determination module is configured to determine whether the network monitoring apparatus is a target node of the address resolution protocol request packet, based on the target network address in the received address resolution protocol request packet, in response to the reception of the address resolution protocol request packet and
the spoofed address resolution protocol reply transmission module is configured to transmit a spoofed address resolution protocol reply packet to the unauthorized node if the network monitoring apparatus is the target node, the spoofed address resolution protocol reply packet including the physical address of the unauthorized node as a sender physical address and the network address of the target node as a sender network address.

6. The network monitoring apparatus of claim 1, wherein the unauthorized node determination module is configured to determine whether the target node of an address resolution protocol request packet is an unauthorized node, based on the target network address in the address resolution protocol request packet, in response to the transmission of the address resolution protocol request packet from the network monitoring apparatus and
the spoofed address resolution protocol reply transmission module is configured to transmit a spoofed address resolution protocol reply packet to the target node if the target node is an unauthorized node, the spoofed address resolution protocol reply packet including the physical address of the target node as a sender physical address and the network address of the network monitoring apparatus as a sender network address.

7. The network monitoring apparatus of claim 1, wherein the unauthorized node determination module is configured to ignore the address resolution protocol request packet if the sender node of the received address resolution protocol request packet is an unauthorized node and the received address resolution protocol request packet is a Gratuitous address resolution protocol request packet.

8. A network monitoring method of monitoring a network to which nodes are connected by use of a network monitoring apparatus connected to the network, the network monitoring method comprising:
determining, by the network monitoring apparatus, whether a sender node which transmits an address resolution protocol request packet is an unauthorized node, based on a sender physical address in the address resolution protocol request packet, in response to the reception of the address resolution protocol request packet;
transmitting, by the network monitoring apparatus, a spoofed address resolution protocol request packet to a target node corresponding to a target network address in the received address resolution protocol request packet if the sender node is an unauthorized node, the spoofed address resolution protocol request packet including a network address of the target node as a target network address, a physical address of the network monitoring apparatus as a sender physical address and a network address of the unauthorized node as a sender network address;
receiving, by the network monitoring apparatus, an address resolution protocol reply packet from the target node, wherein the target node is configured to unicast the address resolution protocol reply packet to the network monitoring apparatus in response to the reception of the spoofed address resolution protocol request packet, and wherein the address resolution protocol reply packet includes the physical address of the network monitoring apparatus as a target physical address, the network address of the unauthorized node as a target network address, a physical address of the target node as a sender physical address, and the network address of the target node as a sender network address; and
transmitting, by the network monitoring apparatus, a spoofed address resolution protocol reply packet to the unauthorized node in response to the reception of an address resolution protocol reply packet unicast from the target node to the network monitoring apparatus with respect to the spoofed address resolution protocol request packet, the spoofed address resolution protocol reply packet including a physical address of the unauthorized node as a sender physical address and a network address of the target node as a sender network address.

9. A network monitoring apparatus which is configured to monitor a network to which nodes are connected, the network monitoring apparatus comprising:
a processor; and
a memory that comprises
an first module configured to determine whether a sender node which transmits an address resolution protocol request packet is an unauthorized node based on a sender physical address in the address resolution protocol request packet, in response to the reception of the address resolution protocol request packet,
a second module configured to transmit a spoofed address resolution protocol request packet to a target node corresponding to a target network address in the received address resolution protocol request packet if the sender node is an unauthorized node, the spoofed address resolution protocol request packet including a network address of the target node as a target network address, a physical address of the network monitoring apparatus as a sender physical address and a network address of the unauthorized node as a sender network address,
a third module configured to receive an address resolution protocol reply packet from the target node, wherein the target node is configured to unicast the address resolution protocol reply packet to the network monitoring apparatus in response to the reception of the spoofed address resolution protocol request packet, and wherein the address resolution protocol reply packet includes the physical address of the network monitoring apparatus as a target physical address, the network address of the unauthorized node as a target network address, a physical address of the target node as a sender physical address, and the network address of the target node as a sender network address, and
a fourth module configured to transmit a spoofed address resolution protocol reply packet to the unauthorized node in response to the reception of the address resolution protocol reply packet, the spoofed address resolution protocol reply packet including a predetermined physical address other than the physical address of the target node as a sender physical address and a network address of the target node as a sender network address.

10. The network monitoring apparatus of claim 9, wherein the fourth module is configured to transmit a spoofed address resolution protocol reply packet to the unauthorized node in response to the reception of the address resolution protocol reply packet, the spoofed address resolution protocol reply packet including a physical address of the unauthorized node as a sender physical address and a network address of the target node as a sender network address.

11. The network monitoring apparatus of claim 9, further comprising an address resolution protocol (ARP) table spoof module configured to write the network address of the unauthorized node and the physical address of the network monitoring apparatus in association with each other into an ARP table of the network monitoring apparatus in which the correspondence between network addresses and physical addresses has been written.

12. The network monitoring apparatus of claim 9, wherein the first module is configured to determine whether the target node of the address resolution protocol request packet is an unauthorized node, based on the target network address in the address resolution protocol request packet, in response to the reception of the address resolution protocol request packet and
the second module is configured to transmit a spoofed address resolution protocol request packet to the sender node of the received address resolution protocol request packet if the target node is an unauthorized node, the spoofed address resolution protocol request packet including the physical address of the network monitoring apparatus as a sender physical address and the network address of the unauthorized node as a sender network address.

13. The network monitoring apparatus of claim 9, wherein the first module is configured to determine whether the network monitoring apparatus is a target node of the address resolution protocol request packet, based on the target network address in the received address resolution protocol request packet, in response to the reception of the address resolution protocol request packet and
the fourth module is configured to transmit a spoofed address resolution protocol reply packet to the unauthorized node if the network monitoring apparatus is the target node, the spoofed address resolution protocol reply packet including the physical address of the unauthorized node as a sender physical address and the network address of the target node as a sender network address.

14. The network monitoring apparatus of claim 9, wherein the first module is configured to determine whether the target node of an address resolution protocol request packet is an unauthorized node, based on the target network address in the address resolution protocol request packet, in response to the transmission of the address resolution protocol request packet from the network monitoring apparatus and
the fourth module is configured to transmit a spoofed address resolution protocol reply packet to the target node if the target node is an unauthorized node, the spoofed address resolution protocol reply packet including the physical address of the target node as a sender physical address and the network address of the network monitoring apparatus as a sender network address.

15. The network monitoring apparatus of claim 9, wherein the first module is configured to ignore the address resolution protocol request packet if the sender node of the received address resolution protocol request packet is an unauthorized node and the received address resolution protocol request packet is a Gratuitous address resolution protocol request packet.
